(19) United States
(12) Patent Application Publication
(10) Pub. No.: US 2023/0039833 A1
(43) Pub. Date: Feb. 9, 2023

(54) SYSTEMS AND METHODS FOR GENERATING ENTERPRISE DATA USING BASE-LINE PROBABLE ROOF LOSS CONFIDENCE SCORES

(71) Applicant: STATE FARM MUTUAL AUTOMOBILE INSURANCE COMPANY, Bloomington, IL (US)

(72) Inventors: Joshua M. Mast, Bloomington, IL (US); Douglas L. Dewey, Bloomington, IL (US); Todd Binion, Bloomington, IL (US); Jeffrey Feid, Normal, IL (US)

(21) Appl. No.: 17/380,144

(22) Filed: Jul. 20, 2021

(51) Int. Cl. G06Q 40/08; G06Q 40/02; G06Q 10/00; G06Q 30/02; G06Q 50/16; G01W 1/00

(52) U.S. Cl. CPC G06Q 40/08; G06Q 40/025; G06Q 10/20; G06Q 30/0283; G06Q 30/0278; G06Q 50/163; G01W 1/00

(57) ABSTRACT

Apparatuses, systems and methods are provided for generating enterprise data relating to roof damage associated with weather and hail data. The apparatuses, systems and methods may determine aspects of a proposed service related to roof damage (e.g., damage extent, repair estimates, or repair timing) based upon the enterprise data and the base-line probable roof loss confidence scores. The apparatuses, systems and methods may generate probable roof loss confidence score data based upon the base-line probable roof loss confidence scores, weather event data and hail event data. The apparatuses, systems and methods may determine aspects of a proposed service related to roof damage (e.g., damage extent, repair estimates, or repair timing) based upon the enterprise data and the probable roof loss confidence score.

### TECHNICAL FIELD

The present disclosure relates generally to determining roof damage resulting from weather and hail, and, more particularly, to apparatuses, systems and methods for determining enterprise data based on base-line probable roof loss confidence scores generated using weather and hail data, and determining aspects of a service for a building based on the enterprise data.

### BACKGROUND

Storms may cause damage (e.g., wind damage, hail damage, rain damage, ice damage, etc.) to an exterior of a building (e.g., a roof of a building, siding on a building, exterior windows of a building, etc.). A roof of a building, for example, may represent a line of defense against additional property damage from high winds, rain, ice and hail.

Accordingly, identifying damaged buildings as soon as possible after a storm and repairing the damage (at least temporarily) is desirable. For example, a hail storm may damage a roof of a building to an extent that water may leak through the roof causing additional damage to the roof and/or other portions of the building.

Large-scale storms may impact a geographic area that may include thousands of buildings. Insurance companies, for example, may receive hundreds of thousands of insurance claims each year associated with storm damage. While an insurance company may be motivated to repair initial storm damage soon after an associated storm, the insurance company has to avoid payment of unnecessary claims. Often times, for example, an insurance company will dispatch an insurance adjustor to a property site in order to assess storm damage claims.

An insurance company may wish to expedite the claim process. Moreover, an insurance company may or may not be obligated to pay a claim based on the collected data and the applicable insurance contract. Moreover, an insurance company may be obligated to pay a claim based on an associated insurance contract.

Apparatuses, systems and methods are needed to expedite property damage insurance claims that are associated with storm damage. Apparatuses, systems and methods are also needed to generate a probable building exterior damage confidence score for an exterior of at least one building. Apparatuses, systems and methods are further needed to generate a base-line probable roof damage confidence score for a roof of at least one building. Apparatuses, systems and methods are further needed to generate property insurance underwriting data based on a base-line probable roof damage confidence score for a roof of at least one building. Apparatuses, systems and methods are further still needed to generate enterprise data and determine aspects of needed services based on base-line probable roof damage confidence scores. Apparatuses, systems and methods are yet further needed to generate a probable roof damage confidence score for a roof of at least one building. Apparatuses, systems and methods are needed to generate insurance property damage claim data based on a probable roof damage confidence score. Apparatuses, systems and methods are needed to generate insurance property loss mitigation data based on a probable roof damage confidence score. Apparatuses, systems and methods are also needed to generate enterprise data and determine aspects of needed services based on probable roof damage confidence scores.

### SUMMARY

Systems, computer-implemented methods, and computer-readable medium storing computer-readable instructions for generating enterprise data relating to roof damage and determining aspects of services for buildings are disclosed hereon. In one embodiment, a computer-implemented method for determining an aspect of a service for a building includes receiving, at one or more processors, building data representative of attributes of a building. The building data may include a geographical location of the building. The method may also include obtaining, by the one or more processors and based upon the building data, (i) roof data representative of a structure forming a roof of the building, (ii) historical weather data representative of storm attributes associated with historical storms that have occurred in a geographic area that includes the geographic location of the building, (iii) historical hail data representative of attributes of historical hail that has impacted a geographic area that includes the geographic location of the building, and/or (iv) climate zone/region data associated with the geographic location of the building. The method may further include generating, by the one or more processors, base-line probable roof loss confidence scores based upon the building data, the roof data, the historical weather data, the historical hail data, and the climate zone/region data. The base-line probable roof loss confidence scores may represent likelihoods that the roof of the building will need replacement or repair in respective future years. The method may further still include determining, by the one or more processors, expected values of a quality metric of the roof to the value of the building for the future years based upon the roof data and the base-line probable roof loss confidence scores. The method may also further include determining, by the one or more processors, an aspect of a service for the building based upon the expected values of the quality metric of the roof.

In another embodiment, a non-transitory, computer-readable medium stores instructions that, when executed by one or more processors, cause a system to receive building data representative of attributes of a building. The building data may include a geographical location of the building. The instructions, when executed by the one or more processors, may cause the system to obtain, based upon the building data, (i) roof data representative of a structure forming a roof of the building, (ii) historical weather data representative of storm attributes associated with historical storms that have occurred in a geographic area that includes the geographic location of the building, (iii) historical hail data representative of attributes of historical hail that has impacted a geographic area that includes the geographic location of the building, and/or (iv) climate zone/region data associated with the geographic location of the building. The building data may include a geographical location of the building. The instructions, when executed by the one or more processors, may further cause the system to generate base-line probable roof loss confidence scores based upon the building data, the roof data, the historical weather data, the historical hail data and the climate zone/region data. The base-line probable roof loss confidence scores may represent likelihoods that the roof of the building will need replacement or repair in respective future years. The building data may include a geographical location of the building. The instructions, when executed by the one or more processors, may still further cause the system to determine expected values of a quality metric of the roof to the value of the building for the future years based upon the roof data and the base-line probable roof loss confidence scores. The building data may include a geographical location of the building. The instructions, when executed by the one or more processors, may even further cause the system to determine an aspect of a service for the building based upon the expected values of the quality metric of the roof.

In yet another embodiment, a computer-implemented method for proposing a service for a roof of a building includes receiving, at one or more processors, building data representative of attributes of a building. The building data may include a geographical location of the building. The method may also include obtaining, by the one or more processors and based upon the building data, (i) roof data representative of a structure forming a roof of the building, (ii) historical weather data representative of storm attributes associated with historical storms that have occurred in a geographic area that includes the geographic location of the building, (iii) historical hail data representative of attributes of historical hail that has impacted a geographic area that includes the geographic location of the building, and/or (iv) climate zone/region data associated with the geographic location of the building. The method may further include generating, using the one or more processors, base-line probable roof loss confidence scores based upon the building data, the roof data, the historical weather data, the historical hail data and the climate zone/region data. The base-line probable roof loss confidence scores may represent likelihoods that the roof of the building will need replacement or repair in respective future years. The method may further still include determining, using the one or more processors, probable costs associated with maintaining or replacing the roof in the future years based upon the base-line probable roof loss confidence scores. The method may even further include proposing a service to be performed on the roof based upon the probable costs, the building data, the roof data, the historical weather data, the historical hail data and the climate zone/region data.

### BRIEF DESCRIPTION OF THE FIGURES

The figures described below depict various aspects of computer-implemented methods, systems comprising computer-readable media, and electronic devices disclosed therein. It should be understood that each figure depicts an embodiment of a particular aspect of the disclosed methods, media, and devices, and that each of the figures is intended to accord with a possible embodiment thereof. Further, wherever possible, the following description refers to the reference numerals included in the following figures, in which features depicted in multiple figures are designated with consistent reference numerals. The present embodiments are not limited to the precise arrangements and instrumentalities shown in the figures.

FIGS. 1A-G depict various views of an example building site;

FIGS. 2A and 2B depict example climate region/zone information for the United States;

FIG. 3 depicts a block diagram of an example computing system related to property insurance;

FIG. 4A depicts a block diagram of an example probable roof loss confidence score computing device;

FIG. 4B depicts an example method of generating a base-line probable roof loss confidence score;

FIG. 4C depicts an example method of generating verified base-line probable roof loss confidence score data;

FIG. 4D depicts an example method of generating verified probable roof loss confidence score data;

FIG. 4E depicts an example method of generating property insurance underwriting data based on base-line probable roof loss confidence score data;

FIG. 4F depicts an example method of generating a probable roof loss confidence score;

FIG. 4G depicts an example method of generating property insurance claims data based on probable roof loss confidence score data;

FIG. 4H depicts an example method of generating insurance property loss mitigation data based on probable roof loss confidence score data;

FIG. 5A depicts an example building computing device;

FIG. 5B depicts an example method of implementing a building computing device;

FIG. 6A depicts an example roof computing device;

FIG. 6B depicts an example method of implementing a roof computing device;

FIG. 7A depicts an example weather computing device;

FIG. 7B depicts an example method of implementing a weather computing device;

FIG. 8A depicts an example hail computing device;

FIG. 8B depicts an example hail of implementing a building computing device;

FIG. 9A depicts an example climate zone computing device; and

FIG. 9B depicts an example method of implementing a climate zone computing device.

FIG. 10 depicts a block diagram of an example computing system related to determining needed services.

FIG. 11 depicts an example method of determining aspects of a service for a building based on base-line probable roof loss confidence score data.

FIG. 12 depicts an example method of determining aspects of a service for a building based on probable roof loss confidence score data.

The figures depict aspects of the invention for purposes of illustration only. One skilled in the art will readily recognize from the following discussion that alternate aspects of the structures and methods illustrated herein may be employed without departing from the principles of the invention described herein.

### DETAIL DESCRIPTION

As noted above, roof damage resulting from weather events such as strong storms and hail is a significant problem. While generalized estimates of susceptibility to damage have been used in insurance underwriting processes, such estimates lack sufficient accuracy for some purposes (e.g., determining an extent of damage to a roof of a particular building from a particular weather event). Additionally, existing processes of estimating likelihoods of damage are unable to accurately determine roof damage for a structure (either generally or based upon a specific weather event) without requiring an inspection of the roof to identify indicia of damage. Accurately determining roof damage without inspecting the roof is particularly useful in situations where large areas are affected by severe weather events, such that a large number of buildings may need to be assessed to determine whether they have suffered roof damage. To improve the accuracy and efficiency of determining roof damage, the techniques disclosed herein obtain and analyze data relating to area-specific and building-specific conditions to generate building-specific predicted levels of roof damage. Unlike general risk level estimates, such building-specific predicted levels of roof damage provide actionable information regarding specific buildings, such as whether a roof of a building should be repaired or replaced. The actionable information also streamlines the process of performing necessary repairs or replacements to a roof as compared to generalized estimates. When using generalized estimates, a first entity (e.g., roof repair team, roof replacement team, roof damage appraiser, etc.) may make an unnecessary trip to the building. If the first entity is not capable of performing the necessary repairs, or in the case where the damage is too costly to repair and the roof must be replaced, a second entity must likewise travel to the building before repairs can begin. Additional costs are incurred when the first entity and the second entity must both travel to the building to repair or replace the roof. By determining the extent of damage to the roof shortly after the damage is caused, the time and costs involved to currently process an insurance claim may be reduced.

It has also been found that building-specific predictions of roof damage may be useful for other purposes beyond determining whether a roof should be repaired or replaced. Thus, to extend the usefulness of building-specific predicted levels of roof damage, techniques disclosed herein make area-specific and/or building-specific information related to roofs and roof damage disclosed herein available as enterprise data. Such enterprise data can thus be shared and used by multiple users of an organization that generated the area-specific and/or building-specific information. For example, the enterprise data may be shared across departments that provide a plurality of different services related to roofs and roof damage. The enterprise data may additionally and/or alternatively be shared with third-party entities to facilitate the provision or performance of services related to roofs and roof damage.

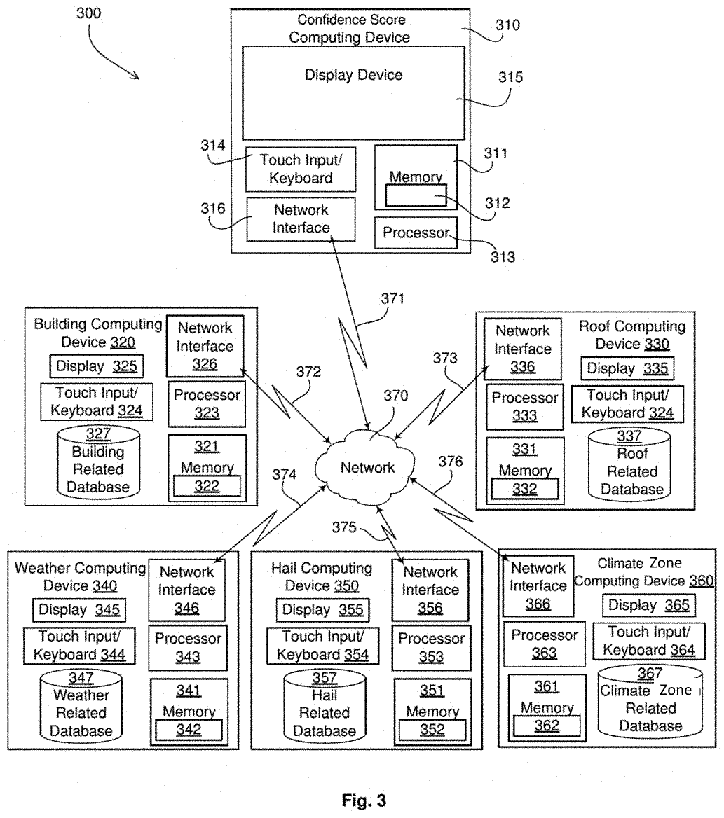

An insurance company, for example, may implement a system (e.g., a computing system 300 of FIG. 3) to underwrite property insurance for a building. For example, a potential insurance customer may request a quote for property insurance for a building from an insurance company. As described in detail herein, the system 300 may generate a base-line probable roof loss confidence score for a roof of the building based on, for example, building data (e.g., a geographic location of a building (e.g., latitude, longitude, etc.), a date on which a building was built, etc.), roof data (e.g., a type of roofing material, an impact resistance rating of a roofing material, a date on which a roof was installed, number of layers, roof area (exposure), a wind resistance rating of a roofing material, manufacturer defects present, orientation of roof structural elements relative to potential damaging effects/direction of store, etc.), historical weather data (e.g., historical wind speeds associated with historical storms in a geographic area associated with the building, historical wind directions associated with historical storms in a geographic area associated with the building, historical lengths of time of historical storms that impacted a geographic area associated with the building, etc.), historical hail data (e.g., sizes of hail that have historically impacted a geographic area associated with the building, hardness of hail that have historically impacted a geographic area associated with the building, lengths of time hail historically impacted a geographic area associated with the building, a three-dimensional shape of the hail that has historically impacted a geographic area associated with the building, etc.). A base-line probable roof loss confidence score may represent a likelihood that the roof of the building will need replacement or repair in a particular future year.

In another example, the insurance company may implement the system 300 to respond to and/or anticipate property damage claims. For example, a storm may impact a geographic area that includes at least one building that is insured by the company. The apparatuses, systems and methods, as described herein, may be incorporated into an insurance claims process, and may be reflected in a recommended policyholder claim payment under the terms of an associated insurance contract. As described in detail herein, the system 300 may generate a probable roof loss confidence score for the roof of the building based on, for example, base-line roof loss confidence score data (e.g., base-line probable roof loss confidence score data generated at the time of property insurance underwriting), weather data (e.g., a geographic area impacted by a storm, wind speed associated with a storm, wind direction associated with a storm, a length of time a storm impacted a particular geographic location, etc.), and hail data (e.g., a size of hail, a hardness of hail, a length of time hail impacted a geographic area, a three-dimensional shape of the hail, etc.). A probable roof loss confidence score represents a likelihood of a particular storm or a particular hail event causing damage to the roof (e.g., a total loss of the roof).

Additionally, apparatuses, systems and methods are provided that may expedite property damage insurance claims associated with storm damage. Apparatuses, systems and methods are also provided that may generate a probable building exterior damage confidence score for an exterior of at least one building. Apparatuses, systems and methods are further provided that may generate a base-line probable roof damage confidence score for a roof of at least one building. Apparatuses, systems and methods are provided that may generate property insurance underwriting data based on a base-line probable roof damage confidence score. Apparatuses, systems and methods are provided that may generate a probable roof damage confidence score for a roof of at least one building. Apparatuses, systems and methods are provided that may generate insurance property damage claim data based on a probable roof damage confidence score. Apparatuses, systems and methods are provided that may generate insurance property loss mitigation data based on a probable roof damage confidence score.

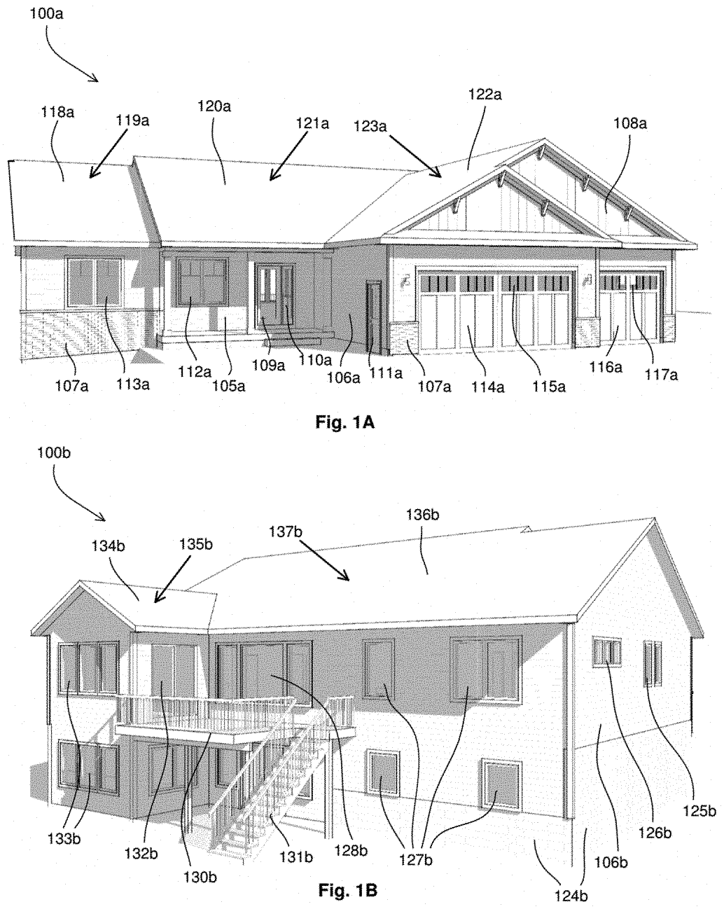

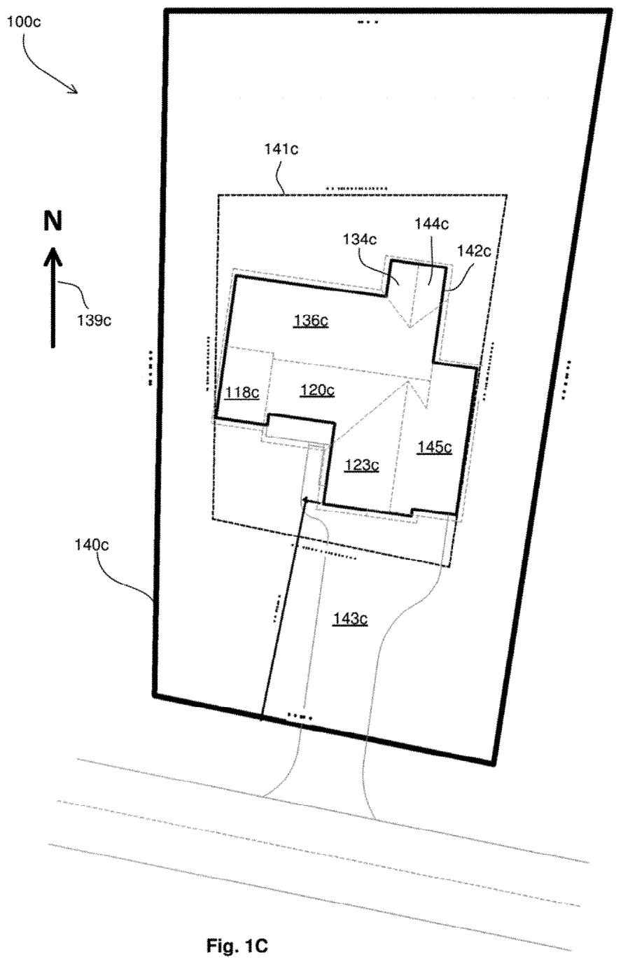

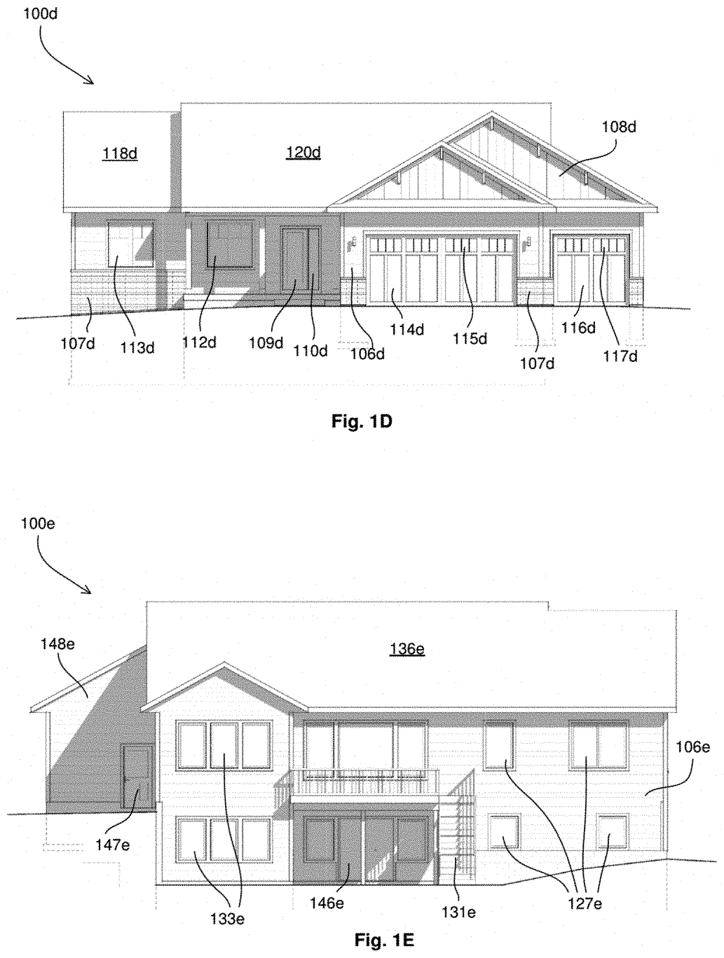

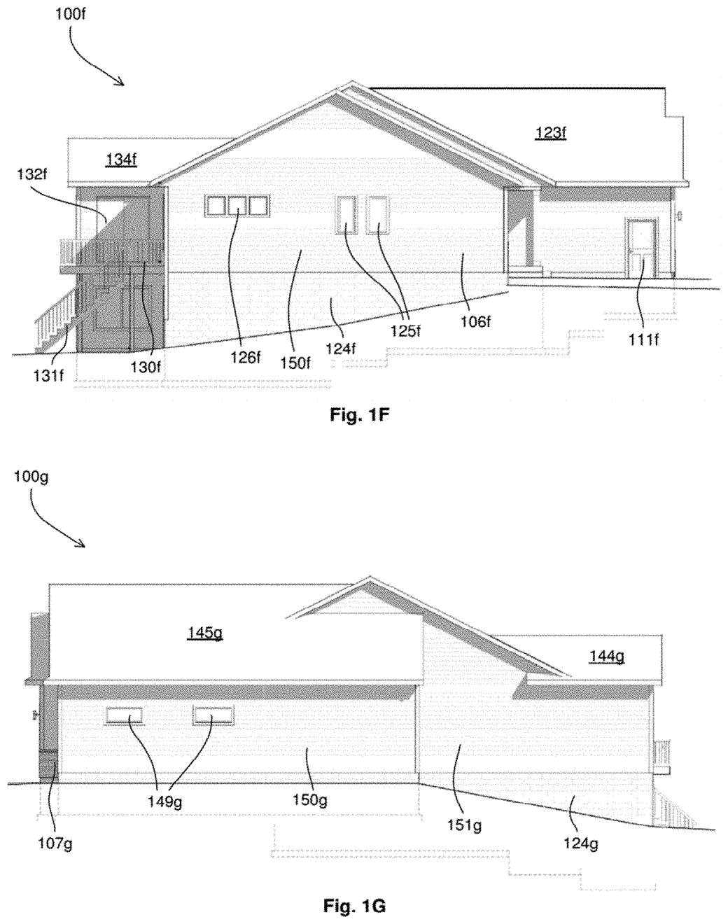

Turning to FIGS. 1A-G, a building site 100a-g may include a building 142c physically located on a building site 140c. The building 142c may be oriented relative to geographic cardinal directions 139c within a building area 141c. The building 142c may include a plurality of roof sections 118a,c,d, 120a,c,d, 122a,c,f, 134b,c,f, 136b,c,e, 144c,g, 145c,g. As specifically illustrated with respect to FIGS. 1A and 1B, line 119a is tangent to a plane associated with roof section 118a,c,d; line 121a is tangent to a plane associated with roof section 120a,c,d; line 123a is tangent to a plane associated with roof section 122a,c,f; line 135b is tangent to a plane associated with roof section 134b,c,f; and line 119a is tangent to a plane associated with roof section 136b,c,e. As described herein, hail, wind, rain, etc. may impact any given roof section 118a,c,d, 120a,c,d, 122a,c,f, 134b,c,f, 136b,c,e, 144c,g, 145c,g relative to a respective tangent line 119a, 121a, 123a, 135b, 137b differently than any other roof section. In any event, a building site 140c may include an access drive 143c.

The building 142c may include a front 105a (i.e., the front 105a is oriented generally SSW with respect to geographic cardinal directions 139c) having exterior siding 106a,b,d,e (e.g., vinyl siding, wood siding, laminate siding, aluminum siding, etc.), cultured stone exterior 107a,b,g, shake exterior siding 108a,d, a front entrance door 109a,d, a sidelight 110a,d, a garage walk-in door 111a,f, a front porch window 112a,d, a picture window 113a,d, a two-car garage door 114a,d with windows 115a,d, and a one-car garage door 116a,d with windows 117a,d.

The building 142c may include a rear 148e (i.e., the rear 148e is oriented generally NNE with respect to geographic cardinal directions 139c) having a rear walk-in garage door 147e, rear windows 127b,e, 133b,e, sliding rear doors 128b, 132b,f, 146e, and a rear deck 130b,f with steps 131b,f.

The building 142c may include a first side 150f (i.e., the first end 150f is oriented generally WNW with respect to geographic cardinal directions 139c) having exterior windows 125f, 126f and basement exterior wall 124f. The building 142c may include a second side 151g (i.e., the second end 151g is oriented generally ESE with respect to geographic cardinal directions 139c) having exterior windows 149g and basement exterior wall 124f.

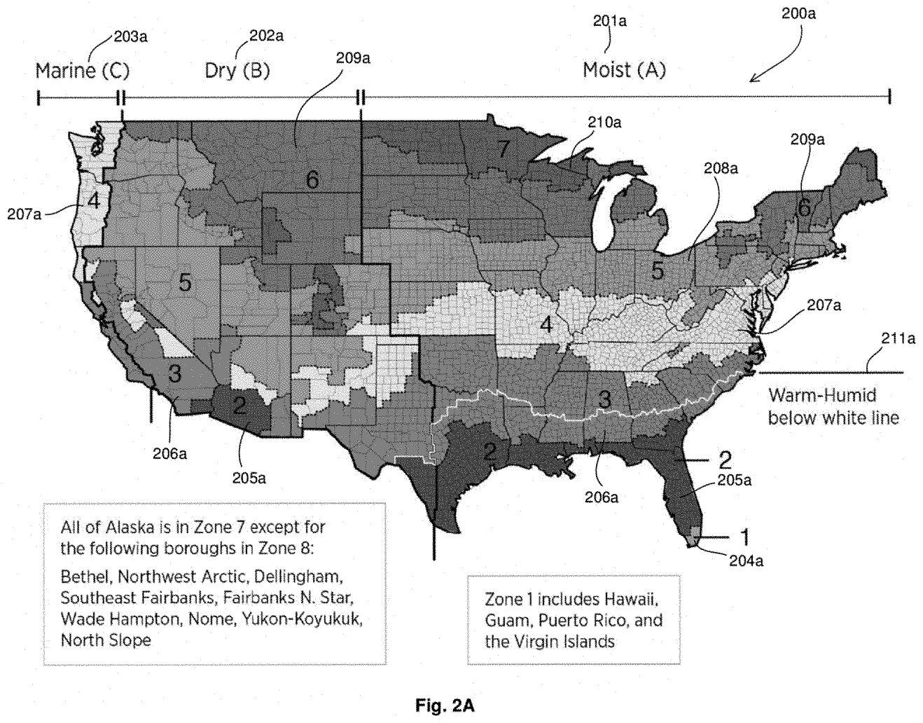

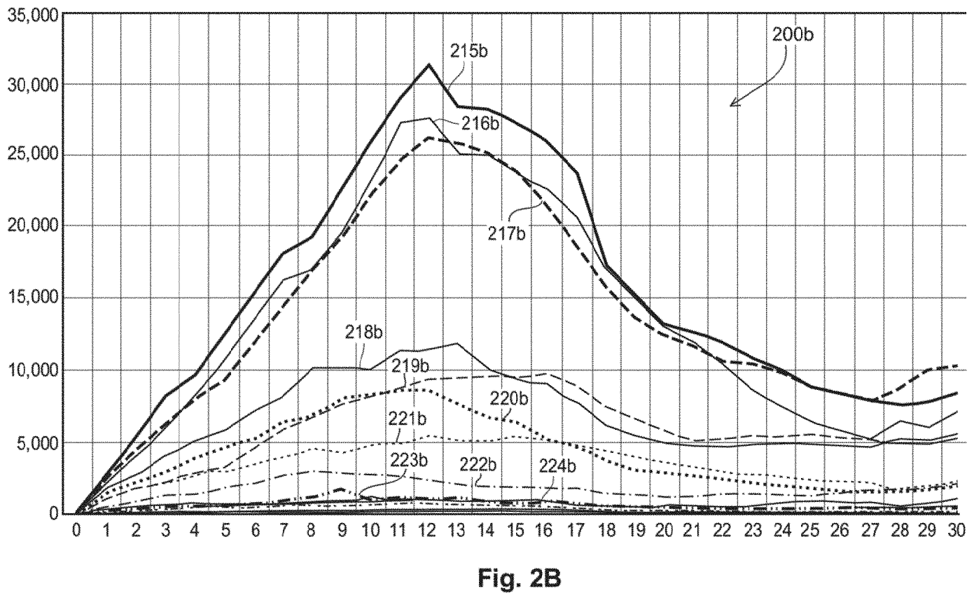

With reference to FIGS. 2A and 2B, climate region/zone information for the United States 200a may include three generally latitudinally extending columns 201a-203a (i.e., “moist (A)”, “dry (B)”, and “Marine (C)”), with each column 201a-203c divided into seven generally longitudinally extending rows 204a-210a (i.e., “Zones 1-7”). Each climate zone may then be referenced as, for example, “5A” or “4C” (i.e., climate zone graph lines 215b-224b).

As illustrated in FIG. 2B, a graph 200b may illustrate how exterior building material performance (e.g., roofing material, siding material, windows, gutters, down spouts, etc.) may vary with respect to a climate zone within which an associated building 142c is physically located. For example, a building located in climate zone 215b (i.e., climate zone 5A) may be more likely to experience building exterior damage (e.g., roof damage, siding damage, exterior widow damage, gutter damage, down spout damage, etc.) compared to a building located in climate zone 217b (i.e., climate zone 4C).

The X-Axis of the graph of FIG. 2B may, for example, be representative of a calculated roof age (CRA) for an asphalt composite shingle, shown as ranging from 0-30 years. The Y-Axis of the graph of FIG. 2B may, for example, be representative of a claim count, shown as ranging from 0-35,000. Certain assumptions may be employed to complete a respective data set that includes an estimated roof year (RY), if an actual roof year is, for example, not included in an initial insurance policy data extraction. Associated assumptions may include: 1) roof year (RY)=roof install year (RIY) (Notably, a roof year (RY) may be a pre-populated field in an insurance company policy master data set); 2) If the roof year (RY) field is blank in an associated entry of a roof data set, then roof year (RY)=Year Built (YB). (Notably, a year built (YB) is typically available data, and homes with a year built (YB)< or =30 years of age may be used as research has shown that the life cycle for most asphalt composition shingles is less than the designated 30 year period). Thus, an assumption may be made that a current roof is the original roof. (Notably, an automated confirmation protocol may be incorporated to review if a policy for a particular building location has had a prior wind or hail claim that warranted a complete roof replacement (i.e., If yes, an updated Roof Year (RY) may be used)); and 3) a final formula for determining roof age may include a calculated roof age (CRA)=data extraction date (DED)−roof year (RY). For example, if the data extraction date (DED) was year-end 2017 and the roof year (RY) was 2003, the calculated roof age (CRA) is equal to 14 years.

Turning to FIG. 3, a computer system related to property insurance 300 may include, for example, a confidence score computing device 310, a building computing device 320, a roof computing device 330, a weather computing device 340, a hail computing device 350, and a climate zone computing device 360 communicatively connected to one another via a communications network 370. For clarity, only one confidence score computing device 310, one building computing device 320, one roof computing device 330, one weather computing device 340, one hail computing device 350, and one climate zone computing device 360 are depicted in FIG. 3. While only one confidence score computing device 310, one building computing device 320, one roof computing device 330, one weather computing device 340, one hail computing device 350, and one climate zone computing device 360 are depicted in FIG. 3, it should be understood that any number of confidence score computing devices 310, building computing devices 320, roof computing devices 330, weather computing devices 340, hail computing devices 350, and climate zone computing devices 360 may be supported within the system 300.

The confidence score computing device 310 may include a memory 311 and a processor 313 for storing and executing, respectively, a module 312. The module 312 may be, for example, stored on the memory 311 as a set of computer-readable instructions that, when executed by the processor 313, may cause the processor 313 to generate a base-line probable roof loss confidence score data, generate property insurance underwriting data, generate probable roof loss confidence score data, generate property insurance claims data, and generate property loss mitigation data. The confidence score computing device 310 may include a touch input/keyboard 314, a display device 315, and a network interface 316 configured to facilitate communications between the confidence score computing device 310, the building computing device 320, the roof computing device 330, the weather computing device 340, the hail computing device 350, and the climate zone computing device 360 via any hardwired or wireless communication network link 371, including for example a wireless LAN, MAN or WAN, WiFi, a wireless cellular telephone network, an Internet connection, or any combination thereof. Moreover, the confidence score computing device 310 may be communicatively connected to the building computing device 320, the roof computing device 330, the weather computing device 340, the hail computing device 350, and the climate zone computing device 360 via any suitable communication system, such as via any publicly available or privately owned communication network, including those that use wireless communication structures, such as wireless communication networks, including for example, wireless LANs and WANs, satellite and cellular telephone communication systems, etc.

The building computing device 320 may include a memory 321 and a processor 323 for storing and executing, respectively, a module 322. The module 322 may be, for example, stored on the memory 321 as a set of computer-readable instructions that, when executed by the processor 323, may cause the processor 323 to provide building data. The building computing device 320 may include a touch input/keyboard 324, a display device 325, and a network interface 326 configured to facilitate communications between the building computing device 320, the confidence score computing device 310, the roof computing device 330, the weather computing device 340, the hail computing device 350, and the climate zone computing device 360 via any hardwired or wireless communication network link 372, including for example a wireless LAN, MAN or WAN, WiFi, a wireless cellular telephone network, an Internet connection, or any combination thereof. Moreover, the building computing device 320 may be communicatively connected to the confidence score computing device 310, the roof computing device 330, the weather computing device 340, the hail computing device 350, and the climate zone computing device 360 via any suitable communication system, such as via any publicly available or privately owned communication network, including those that use wireless communication structures, such as wireless communication networks, including for example, wireless LANs and WANs, satellite and cellular telephone communication systems, etc.

The roof computing device 330 may include a memory 331 and a processor 333 for storing and executing, respectively, a module 332. The module 332 may be, for example, stored on the memory 331 as a set of computer-readable instructions that, when executed by the processor 333, may cause the processor 333 to generate provide roof data. The roof computing device 330 may include a touch input/keyboard 334, a display device 335, and a network interface 336 configured to facilitate communications between the confidence roof device 330, the building computing device 320, the confidence score computing device 310, the weather computing device 340, the hail computing device 350, and the climate zone computing device 360 via any hardwired or wireless communication network link 373, including for example a wireless LAN, MAN or WAN, WiFi, a wireless cellular telephone network, an Internet connection, or any combination thereof. Moreover, the roof computing device 330 may be communicatively connected to the building computing device 320, the confidence score computing device 310, the weather computing device 340, the hail computing device 350, and the climate zone computing device 360 via any suitable communication system, such as via any publicly available or privately owned communication network, including those that use wireless communication structures, such as wireless communication networks, including for example, wireless LANs and WANs, satellite and cellular telephone communication systems, etc.

The weather computing device 340 may include a memory 341 and a processor 343 for storing and executing, respectively, a module 342. The module 342 may be, for example, stored on the memory 341 as a set of computer-readable instructions that, when executed by the processor 343, may cause the processor 343 to provide weather data. The weather computing device 340 may include a touch input/keyboard 344, a display device 345, and a network interface 346 configured to facilitate communications between the weather computing device 340, the building computing device 320, the roof computing device 330, the confidence score computing device 310, the hail computing device 350, and the climate zone computing device 360 via any hardwired or wireless communication network link 374, including for example a wireless LAN, MAN or WAN, WiFi, a wireless cellular telephone network, an Internet connection, or any combination thereof. Moreover, the weather computing device 340 may be communicatively connected to the building computing device 320, the roof computing device 330, the confidence score computing device 310, the hail computing device 350, and the climate zone computing device 360 via any suitable communication system, such as via any publicly available or privately owned communication network, including those that use wireless communication structures, such as wireless communication networks, including for example, wireless LANs and WANs, satellite and cellular telephone communication systems, etc.

The hail computing device 350 may include a memory 351 and a processor 353 for storing and executing, respectively, a module 352. The module 352 may be, for example, stored on the memory 351 as a set of computer-readable instructions that, when executed by the processor 353, may cause the processor 353 to provide hail data. The hail computing device 350 may include a touch input/keyboard 354, a display device 355, and a network interface 356 configured to facilitate communications between the hail computing device 350, the building computing device 320, the roof computing device 330, the weather computing device 340, the confidence score computing device 310, and the climate zone computing device 360 via any hardwired or wireless communication network link 375, including for example a wireless LAN, MAN or WAN, WiFi, a wireless cellular telephone network, an Internet connection, or any combination thereof. Moreover, the hail computing device 350 may be communicatively connected to the building computing device 320, the roof computing device 330, the weather computing device 340, the confidence score computing device 310, and the climate zone computing device 360 via any suitable communication system, such as via any publicly available or privately owned communication network, including those that use wireless communication structures, such as wireless communication networks, including for example, wireless LANs and WANs, satellite and cellular telephone communication systems, etc.

The climate zone computing device 360 may include a memory 361 and a processor 363 for storing and executing, respectively, a module 362. The module 362 may be, for example, stored on the memory 361 as a set of computer-readable instructions that, when executed by the processor 363, may cause the processor 363 to provide climate zone/region data. The climate zone computing device 360 may include a touch input/keyboard 364, a display device 365, and a network interface 366 configured to facilitate communications between the climate zone computing device 360, the building computing device 320, the roof computing device 330, the weather computing device 340, the hail computing device 350, and the confidence score computing device 310 via any hardwired or wireless communication network link 376, including for example a wireless LAN, MAN or WAN, WiFi, a wireless cellular telephone network, an Internet connection, or any combination thereof. Moreover, the climate zone computing device 360 may be communicatively connected to the building computing device 320, the roof computing device 330, the weather computing device 340, the hail computing device 350, and the confidence score computing device 310 via any suitable communication system, such as via any publicly available or privately owned communication network, including those that use wireless communication structures, such as wireless communication networks, including for example, wireless LANs and WANs, satellite and cellular telephone communication systems, etc.

By distributing the memory/data and processing among the confidence score computing devices 310, the building computing devices 320, the roof computing devices 330, the weather computing devices 340, the hail computing devices 350, and the climate zone computing devices 360, the overall capabilities of the system 300 may be optimized. Furthermore, the individual data sources (e.g., the building data, the roof data, the weather data, the hail data, and the climate zone/region data) may be updated and maintained by different entities. Therefore, updating and maintain the associated data is more efficient and secure.

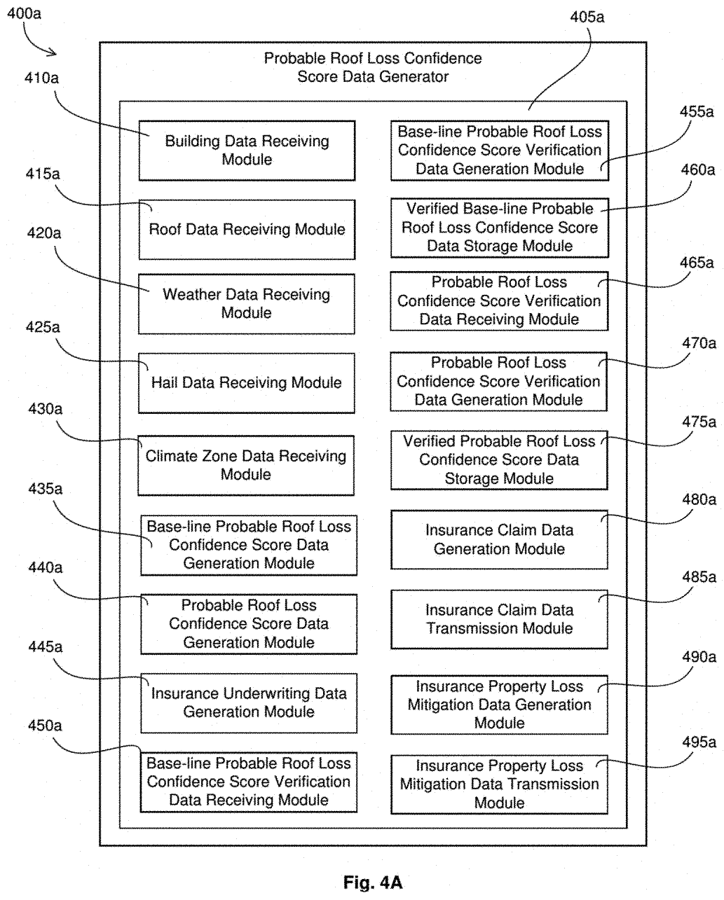

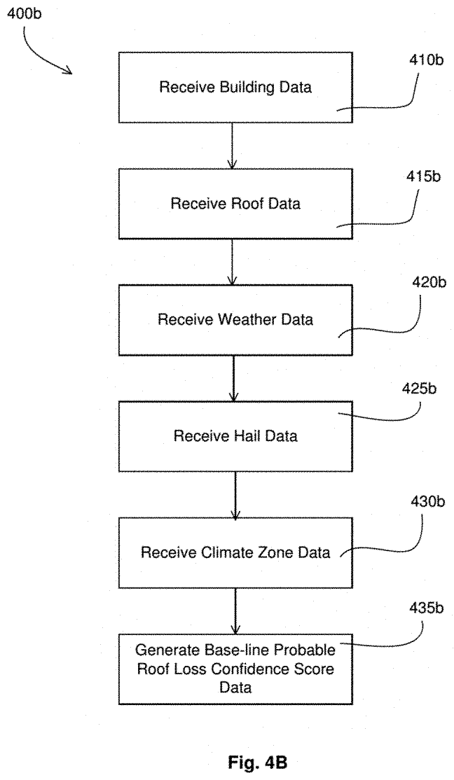

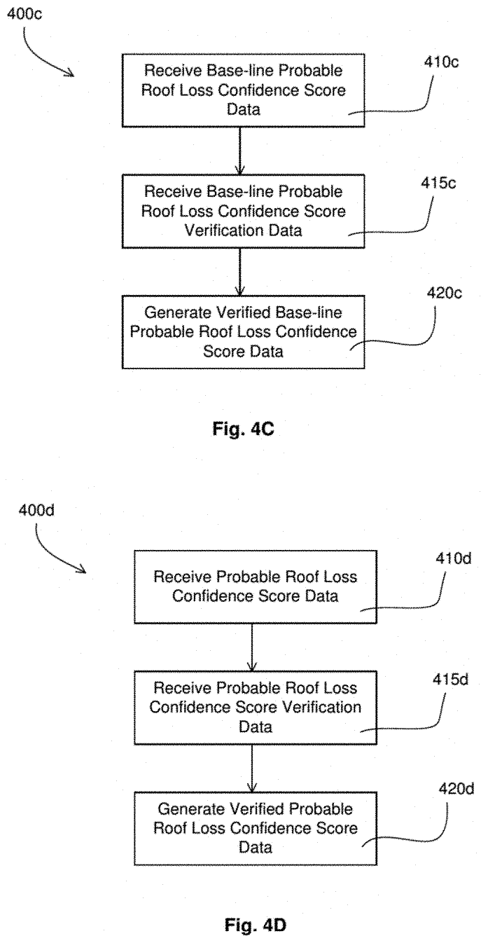

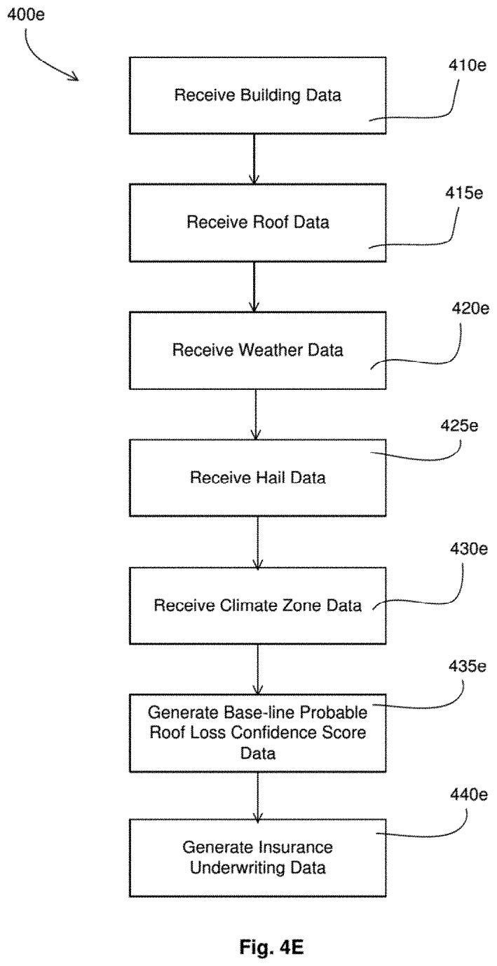

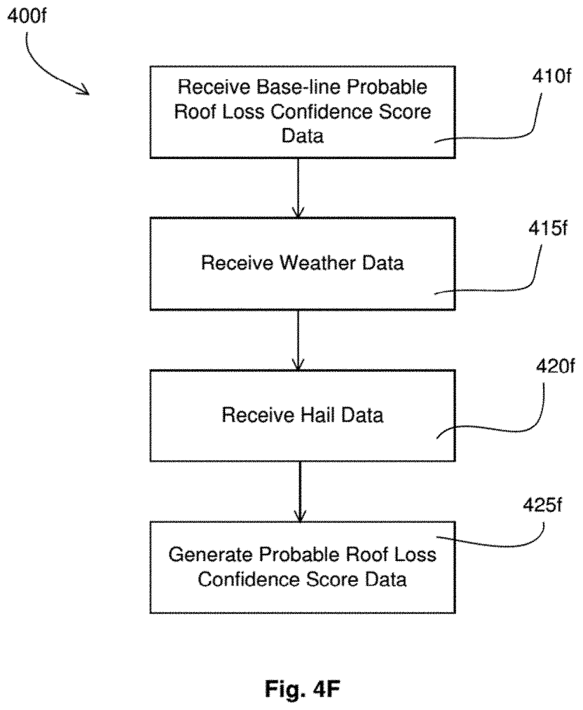

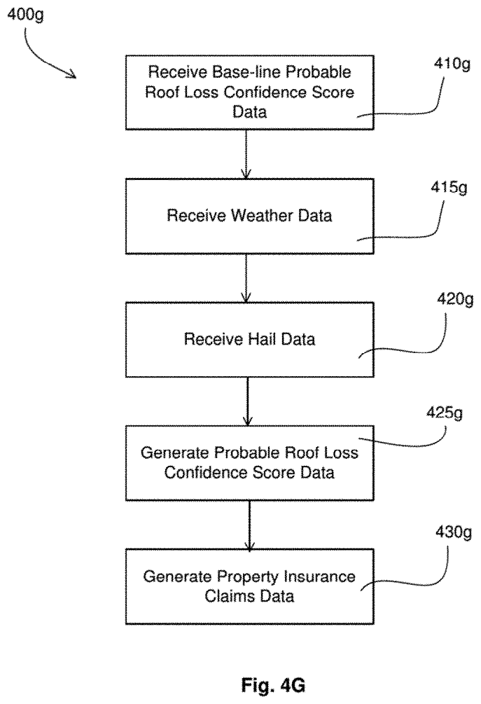

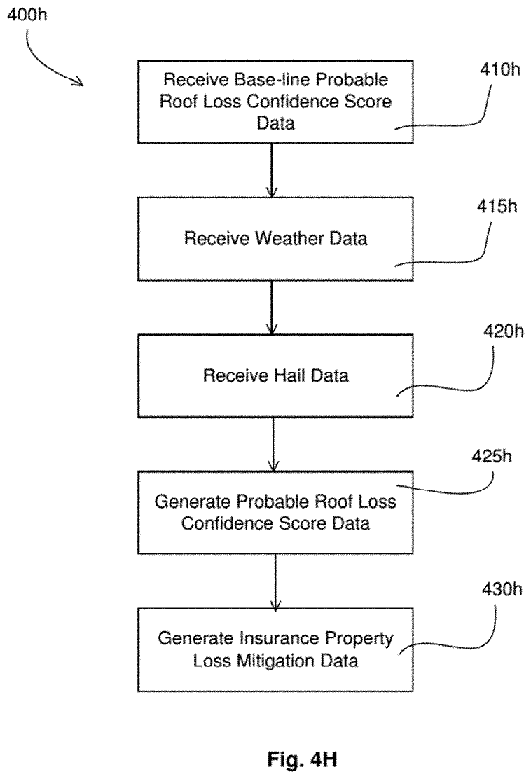

With reference to FIG. 4A, a probable roof loss confidence score computing device 400a may include a building data receiving module 410a, a roof data receiving module 415a, a weather data receiving module 420a, a hail data receiving module 425a, a climate zone data receiving module 430a, a base-line probable roof loss confidence score data generation module 435a, a probable roof loss confidence score data generation module 440a, an insurance underwriting data generation module 445a, a base-line probable roof loss confidence score verification data receiving module 450a, a base-line probable roof loss confidence score verification data generation module 455a, a verified base-line probable roof loss confidence score data storage module 460a, a probable roof loss confidence score verification data receiving module 465a, a probable roof loss confidence score verification data generation module 470a, a verified probable roof loss confidence score data storage module 475a, an insurance claim data generation module 480a, an insurance claim data transmission module 485a, an insurance property loss mitigation data generation module 490a, and an insurance property loss mitigation data transmission module 495a stored on, for example, a memory 405a as a set of computer-readable instructions. The probable roof loss confidence score computing device 400a may be similar to, for example, the confidence score computing device 310 of FIG. 3.

Turning to FIG. 4B, a method of generating a base-line probable roof loss confidence score 400b may be implemented by a processor (e.g., processor 313 of FIG. 3) executing, for example, at least a portion of the modules 410a-495a of FIG. 4A or the module 312 of FIG. 3. In particular, the processor 313 may execute the building data receiving module 410a to cause the processor 313 to, for example, receive building data from a building computing device 320 (block 410b). The building data may be representative of attributes of the building. Attributes of the building include at least one of: a geographic location of the building (e.g., latitude, longitude, etc.), a building orientation relative to geographic cardinal directions, whether the building is single story, whether the building is two story, whether the building is multi-story, whether there is tree cover over the building, location and height of structures surrounding the building, orientation of roof structural elements relative to potential damaging effects/direction of store, or elevation of terrain surrounding the building.

The processor 313 may execute the roof data receiving module 415a to cause the processor 313 to, for example, receive roof data from a roof computing device 430 based on the building data (block 415b). The roof data may be representative of roofing material covering the building. Alternatively, or additionally, the roof data may be representative of a structural truss system that forms a structural design and shape of the roof. Furthermore, the roof data may be representative of a structure forming an upper covering of the building. Typically in construction a reference to a structure is the building itself and or possibly structural components related to its physical construction (e.g., wood frame, steel beam, poured foundation, etc.). The roof data may be representative of at least one of: a roofing product age, roof area, a roofing material type, a roofing design, a roofing configuration, a roofing product condition, whether a roof is a gable roof, whether a roof is a hip roof, a roof slope, a number of layers of roofing material, a roof deck condition, a roofing manufacturer product testing result, a roofing installation criteria, a roofing product impact testing result, a roofing product wind testing result, a roofing installation, whether a roofing product complies with a particular roof impact test standard, whether the roofing product complies with a particular roof impact test protocol, whether the roofing product is impact resistant rated, a roofing product impact resistance rating, a roofing product wind rating, a roofing shingle specification, whether a roofing product was installed during cold conditions with hand-sealed roofing cement, a roof underlayment, a roofing facer technology, a polyiso roofing insulation, an EPS insulation, whether a roof includes roof ventilation, an attic detail, a roofing product manufacture warranty, a roofing product installer warranty, or a roofing product third-party warranty.

The processor 313 may execute the weather data receiving module 420a to cause the processor 313 to, for example, receive historical weather data from a weather computing device 340 based on the building data (block 420b). The historical weather data may be representative of storm attributes associated with historical storms that have occurred in a geographic area that includes a geographic location of the building. The attributes of the storm may include at least one of: a storm meteorological signature, a storm duration, a storm direction, a wind speed, thermal shock, whether a storm is conducive to producing damaging hail, whether a storm is conducive to producing strong winds, key meteorological aspects of a storm, length of time that the storm impacted the roof, a direction from which the storm impacts the building, a roof temperature prior to the storm, a roof temperature after the storm, or a thermal shock to roofing material.

The processor 313 may execute a hail data receiving module 425a to cause the processor 313 to, for example, receive historical hail data from a hail computing device based on the building data (block 425b). The historical hail data may be representative of attributes of historical hail that has impacted a geographic area that includes the geographic location of the building. Attributes of the hail may include at least one of: a physical characteristic of the hail, a size of the hail, a shape of the hail, a density of the hail, a hardness of the hail, a range of hail sizes produced by a storm, or a resistance to flexing of the hail.

The processor 313 may execute the climate zone data receiving module 430a to cause the processor 313 to, for example, receive climate zone/region data from a climate zone computing device 360 based on the building data (block 430b). The climate zone/region data may be representative of at least one of: a climate associated with a geographic location of the building; a humidity associated with a geographic location of the building, a temperature associated with a geographic location of the building, a moisture associated with a geographic location of the building, or whether a geographic location of the building is associated with a marine climate.

The processor 313 may execute the base-line probable roof loss confidence score data generation module 435a to cause the processor 313 to, for example, generate base-line probable roof loss confidence score data based on the building data, the roof data, the weather data, the hail data, and the climate zone/region data (block 435b). A base-line probable roof loss confidence score may represent a likelihood that a roof of a building will need replacement or repair in a respective future year. Execution of the base-line probable roof loss confidence score data generation module 435a may cause the processor 313 to implement a probability function to generate the base-line probable roof loss confidence score data (block 435b). A contribution of a first term of the probability function may be weighted, via a first weighting variable, relative to a second term of the probability function. The first term of the probability function may be based on the roof data. The second term of the probability function may be based on the hail data. The first weighting variable may be dynamically determined based on at least one of: the building data, the roof data, the weather data, the hail data, or the climate zone/region data. For example, if an associated building is located within a climate zone that does not experience hail, the hail data may be associated with a weighting variable of zero.

With reference to FIG. 4C, a method of generating verified base-line probable roof loss confidence score data 400c may be implemented by a processor (e.g., processor 313 of FIG. 3) executing, for example, at least a portion of the modules 410a-495a of FIG. 4A or the module 312 of FIG. 3. In particular, the processor 313 may receive the base-line probable roof loss confidence score data from block 435b (block 410c).

The processor 313 may execute the base-line probable roof loss confidence score verification data receiving module 450a to cause the processor 313 to, for example, receive base-line probable roof loss confidence score verification data (block 415c). The base-line probable roof loss confidence score verification data may be, for example, any of the variables (i.e., data) included in Table 1 below, and may be received from any one of the data sources included in Table 1. The order in which items appear in Table 1 does not representing a ranking or level of importance. Alternatively, or additionally the probable roof loss confidence score verification data may be manually entered.

The processor 313 may execute the base-line probable roof loss confidence score verification data generation module 455a to cause the processor 313 to, for example, generate verified base-line probable roof loss confidence score data based on a comparison of the base-line probable roof loss confidence score data with the base-line probable roof loss confidence score verification data (block 420c).

The processor 313 may execute the verified base-line probable roof loss confidence score data storage module 460a to cause the processor 313 to, for example, store the base-line probable roof loss confidence score data in, for example, the memory 311 if the processor 313 determines that the base-line probable roof loss confidence score data matches the base-line probable roof loss confidence score verification data (block 420c). Alternatively, the processor 313 may store the verified base-line probable roof loss confidence score data in, for example, the memory 311 if the processor 313 determines that the base-line probable roof loss confidence score data does not match the base-line probable roof loss confidence score verification data (block 420c).

TABLE 1

| Item | Variable | Data Source |
|---|---|---|
| A | Storm Signature (Meteorological) | Weather Vendor |
| B | Storm Duration | Weather Vendor |
| C | Storm Direction | Weather Vendor |
| D | Thermal Shock | Weather Vendor |
| E | Hail Size | Weather Vendor |
| F | Hail Shape | Claim File, Homeowner, Crowd Sourcing |
| G | Hail Density | Weather Vendor |
| H | Hail Hardness | Weather Vendor |
| I | Roofing Product Age | Policy Master Record, Year Built Basis, Claim Reason |
| | | Codes (Total Roof Loss), Aerial Imagery Vendor, |
| | | Property Analytics Vendor |
| J | Roof Area (Exposure) | Policy Master Record, Real Property Vendor, or other |
| | | vendor |
| K | Roofing Material Type | Policy Master Record, Claim Record, Real Property |
| | | Vendor or other vendor |
| L | Roofing Design (Configuration) | Real Property Vendor or other vendor |
| M | Roof Slope | Real Property Vendor or other vendor |
| N | Roof Material-No. of Layers | a Real Property Vendor, vendor Inspection or other |
| | | vendor inspection, Claim Inspection, Homeowner |
| O | Roof Deck Condition | a Real Property Vendor, vendor Inspection, Claim |
| | | Inspection, Aerial Imagery Vendor, Property Analytics |
| | | Vendor |
| P | Roofing Material-Impact Testing | Policy Master Record (IRR Credit), Homeowner |
| | Rating | |
| Q | Roofing Material-Wind Testing | Manufacturer Reference Material, Homeowner |
| | Rating | |
| R | Roof Proper Installation (Yes/No) | a Real Property Vendor, vendor Inspection, Claim |
| | | Inspection, Aerial Imagery Vendor |
| S | Climate Zone | Pacific Northwest National Laboratory-U.S. |
| | | Department of Energy’s Building America Program |
| T | Physical Structure (Single Story, | Policy Master Record, Property Analytics Data, Local |
| | Two Story, Bi-Level) orientation | Property Tax Records, Aerial Imagery Vendor |
| | of roof structural elements relative | |
| | potential damaging | |
| | effects/direction of storm | |
| U | On-Sight (Tree Cover Present) | a Real Property Vendor, vendor Inspection or other |
| | | vendor inspection, Claim Inspection, Aerial Imagery |
| | | Vendor |
| V | Risk Location (Latitude, | Policy Master Record |
| | Longitude) | |
| W | Wind Speed | Weather Vendor, Local Weather Station Instruments, |
| | | Homeowner Installed IOT Systems |
| X | Roofing Material-Manufacturer | Vendor Inspection or Claim Inspection |
| | Defect Present (Yes/No) | |

Turning to FIG. 4D, a method of generating verified probable roof loss confidence score data 400d may be implemented by a processor (e.g., processor 313 of FIG. 3) executing, for example, at least a portion of the modules 410a-495a of FIG. 4A or the module 312 of FIG. 3. In particular, the processor 313 may receive the probable roof loss confidence score data from block 425f (block 410d).

The processor 313 may execute the probable roof loss confidence score verification data receiving module 465a to cause the processor 313 to, for example, receive probable roof loss confidence score verification data (block 415d). The probable roof loss confidence score verification data may be, for example, any of the variables (i.e., data) included in Table 1, and may be received from any one of the data sources included in Table 1. Alternatively, or additionally the probable roof loss confidence score verification data may be manually entered.

The processor 313 may execute the probable roof loss confidence score verification data generation module 470a to cause the processor 313 to, for example, generate verified probable roof loss confidence score data based on a comparison of the probable roof loss confidence score data with the probable roof loss confidence score verification data (block 420d).

The processor 313 may execute the verified probable roof loss confidence score data storage module 475a to cause the processor 313 to, for example, store the probable roof loss confidence score data in, for example, the memory 311 if the processor 313 determines that the probable roof loss confidence score data matches the probable roof loss confidence score verification data (block 420d). Alternatively, the processor 313 may store the verified probable roof loss confidence score data in, for example, the memory 311 if the processor 313 determines that the probable roof loss confidence score data does not match the probable roof loss confidence score verification data (block 420d).

With reference to FIG. 4E, a method of generating property insurance underwriting data based on base-line probable roof loss confidence score data 400e may be implemented by a processor (e.g., processor 313 of FIG. 3) executing, for example, at least a portion of the modules 410a-495a of FIG. 4A or the module 312 of FIG. 3. In particular, the processor 313 may execute the building data receiving module 410a to cause the processor 313 to, for example, receive building data from a building computing device 320 (block 410e). The building data may be representative of attributes of the building. Attributes of the building include at least one of: a geographic location of the building (e.g., latitude, longitude, etc.), a building orientation relative to geographic cardinal directions, whether the building is single story, whether the building is two story, whether the building is multi-story, whether there is tree cover over the building, location and height of structures surrounding the building, orientation of roof structural elements relative to potential damaging effects/direction of store, or elevation of terrain surrounding the building.

The processor 313 may execute the roof data receiving module 415a to cause the processor 313 to, for example, receive roof data from a roof computing device 430 based on the building data (block 415e). The roof data may be representative of a structure forming an upper covering of the building. The roof data may be representative of the roofing system covering the building. Alternatively, or additionally, the roof data may be representative of a structural truss system that forms the design and shape of the roof. Furthermore, the roof data may be representative of the roof sheathing, underlayment, roofing felt, membrane, self-adhered water and ice-dam protection membrane, tar, tar paper, exterior roofing material covering, roof vents, flashing and drip edges, and any other component comprising part of the overall roof surface covering of the building. The roof data may be representative of at least one of: a roofing product age, roof area, a roofing material type, a roofing design, a roofing configuration, a roofing product condition, whether a roof is a gable roof, whether a roof is a hip roof, a roof slope, a number of layers of roofing material, a roof deck condition, a roofing manufacturer product testing result, a roofing installation criteria, a roofing product impact testing result, a roofing product wind testing result, a roofing installation, whether a roofing product complies with a particular roof impact test standard or protocol, whether the roofing product is impact resistant rated, a roofing product impact resistance rating, a roofing product wind rating, a roofing shingle specification, whether a roofing product was installed during cold conditions with hand-sealed roofing cement, a roof underlayment, a roofing facer technology, a polyiso roofing insulation, an EPS insulation, whether a roof includes roof ventilation, an attic detail, a roofing product manufacture warranty, a roofing product installer warranty, or a roofing product third-party warranty.

The processor 313 may execute the weather data receiving module 420a to cause the processor 313 to, for example, receive historical weather data from a weather computing device 340 based on the building data (block 420e). The historical weather data may be representative of storm attributes associated with historical storms that have occurred in a geographic area that includes a geographic location of the building. The attributes of the storm may include at least one of: a storm meteorological signature, a storm duration, a storm direction, a wind speed, thermal shock, whether a storm is conducive to producing damaging hail, whether a storm is conducive to producing strong winds, key meteorological aspects of a storm, length of time that the storm impacted the roof, a direction from which the storm impacts the building, a roof temperature prior to the storm, a roof temperature after the storm, or a thermal shock to roofing material.

The processor 313 may execute a hail data receiving module 425a to cause the processor 313 to, for example, receive historical hail data from a hail computing device based on the building data (block 425e). The historical hail data may be representative of attributes of historical hail that has impacted a geographic area that includes the geographic location of the building. Attributes of the hail may include at least one of: a physical characteristic of the hail, a size of the hail, a shape of the hail, a density of the hail, a hardness of the hail, a range of hail sizes produced by a storm, or a resistance to flexing of the hail.

The processor 313 may execute the climate zone data receiving module 430a to cause the processor 313 to, for example, receive climate zone/region data from a climate zone computing device 360 based on the building data (block 430e). The climate zone/region data may be representative of at least one of: a climate associated with a geographic location of the building; a humidity associated with a geographic location of the building, a temperature associated with a geographic location of the building, a moisture associated with a geographic location of the building, or whether a geographic location of the building is associated with a marine climate.

The processor 313 may execute the base-line probable roof loss confidence score data generation module 435a to cause the processor 313 to, for example, generate base-line probable roof loss confidence score data based on the building data, the roof data, the weather data, the hail data, and the climate zone/region data (block 435e). Execution of the base-line probable roof loss confidence score data generation module 435a may cause the processor 313 to implement a probability function to generate the base-line probable roof loss confidence score data (block 435e). A contribution of a first term of the probability function may be weighted, via a first weighting variable, relative to a second term of the probability function. The first term of the probability function may be based on the roof data. The second term of the probability function may be based on the hail data. The first weighting variable may be dynamically determined based on at least one of: the building data, the roof data, the weather data, the hail data, or the climate zone/region data. For example, if an associated building is located within a climate zone that does not experience hail, the hail data may be associated with a weighting variable of zero.

The processor 313 may execute the insurance underwriting data generation module 445a to cause the processor 313 to, for example, generate insurance underwriting data based on the base-line probable roof loss confidence score data (block 440e).

Turning to FIG. 4F, a method of generating a probable roof loss confidence score 400f may be implemented by a processor (e.g., processor 313 of FIG. 3) executing, for example, at least a portion of the modules 410a-495a of FIG. 4A or the module 312 of FIG. 3. In particular, the processor 313 may receive the base-line probable roof loss confidence score data from block 435b (block 410f). The processor 313 may execute the weather data receiving module 420a to cause the processor 313 to, for example, receive weather data from a weather computing device 340 (block 415f). The weather data may be representative of storm attributes associated with storms that have recently occurred in a geographic area that includes a geographic location of the building. The attributes of the storm may include at least one of: a storm meteorological signature, a storm duration, a storm direction, a wind speed, thermal shock, whether a storm is conducive to producing damaging hail, whether a storm is conducive to producing strong winds, key meteorological aspects of a storm, length of time that the storm impacted the roof, a direction from which the storm impacts the building, a roof temperature prior to the storm, a roof temperature after the storm, or a thermal shock to roofing material.

The processor 313 may execute a hail data receiving module 425a to cause the processor 313 to, for example, receive hail data from a hail computing device based on the building data (block 420f). The hail data may be representative of attributes of hail that has recently impacted a geographic area that includes the geographic location of the building. Attributes of the hail may include at least one of: a physical characteristic of the hail, a size of the hail, a shape of the hail, a density of the hail, a hardness of the hail, a range of hail sizes produced by a storm, or a resistance to flexing of the hail.

The processor 313 may execute a probable roof loss confidence score data generation module 440a to cause the processor 313 to, for example, generate probable roof loss confidence score data based on the base-line probable roof loss confidence score data, the weather data, and the hail data (block 425f). Execution of the probable roof loss confidence score data generation module 440a may cause the processor 313 to implement a probability function to generate the base-line probable roof loss confidence score data (block 4250. A contribution of a first term of the probability function may be weighted, via a first weighting variable, relative to a second term of the probability function. The first term of the probability function may be based on the roof data. The second term of the probability function may be based on the hail data. The first weighting variable may be dynamically determined based on at least one of: the base-line probable roof loss confidence score data, the weather data, or the hail data. For example, if an associated building is located within a climate zone that does not experience hail, the hail data may be associated with a weighting variable of zero.

The probable roof loss confidence score data may be, for example, representative of a binary value (i.e., either a roof of the building is determine to be a total loss, or not). Alternatively, the probable roof loss confidence score data may be, for example, representative of a continuous value (i.e., a probability of the roof of the building being a total loss is determine). If the probability is less than some value (e.g., 50%), a manual verification of a roof loss claim may be performed. If the probability is greater than some value (e.g., 50%), the processor may automatically process an associated roof loss claim.

With reference to FIG. 4G, a method of generating property insurance claims data based on probable roof loss confidence score data 400g may implemented by a processor (e.g., processor 313 of FIG. 3) executing, for example, at least a portion of the modules 410a-495a of FIG. 4A or the module 312 of FIG. 3. In particular, the processor 313 may receive the base-line probable roof loss confidence score data from block 435b (block 410g). The processor 313 may execute the weather data receiving module 420a to cause the processor 313 to, for example, receive weather data from a weather computing device 340 (block 415g). The weather data may be representative of storm attributes associated with storms that have recently occurred in a geographic area that includes a geographic location of the building. The attributes of the storm may include at least one of: a storm meteorological signature, a storm duration, a storm direction, a wind speed, thermal shock, whether a storm is conducive to producing damaging hail, whether a storm is conducive to producing strong winds, key meteorological aspects of a storm, length of time that the storm impacted the roof, a direction from which the storm impacts the building, a roof temperature prior to the storm, a roof temperature after the storm, or a thermal shock to roofing material.

The processor 313 may execute a hail data receiving module 425a to cause the processor 313 to, for example, receive hail data from a hail computing device based on the building data (block 420g). The hail data may be representative of attributes of hail that has recently impacted a geographic area that includes the geographic location of the building. Attributes of the hail may include at least one of: a physical characteristic of the hail, a size of the hail, a shape of the hail, a density of the hail, a hardness of the hail, a range of hail sizes produced by a storm, or a resistance to flexing of the hail.

The processor 313 may execute a probable roof loss confidence score data generation module 440a to cause the processor 313 to, for example, generate probable roof loss confidence score data based on the base-line probable roof loss confidence score data, the weather data, and the hail data (block 425g). A probable roof loss confidence score may represent a likelihood of a particular storm or particular hail event causing a total loss of a roof. Execution of the probable roof loss confidence score data generation module 440a may cause the processor 313 to implement a probability function to generate the base-line probable roof loss confidence score data (block 425g). A contribution of a first term of the probability function may be weighted, via a first weighting variable, relative to a second term of the probability function. The first term of the probability function may be based on the roof data. The second term of the probability function may be based on the hail data. The first weighting variable may be dynamically determined based on at least one of: the base-line probable roof loss confidence score data, the weather data, or the hail data. For example, if an associated building is located within a climate zone that does not experience hail, the hail data may be associated with a weighting variable of zero.

The processor 313 may execute an insurance claim data generation module 480a to cause the processor 313 to, for example, generate insurance claim data based on the probable roof loss confidence score data (block 430g). The probable roof loss confidence score data may be, for example, representative of a binary value (i.e., either a roof of the building is determine to be a total loss, or not). Alternatively, the probable roof loss confidence score data may be, for example, representative of a continuous value (i.e., a probability of the roof of the building being a total loss is determine). If the probability is less than some value (e.g., 50%), a manual verification of a roof loss claim may be performed. If the probability is greater than some value (e.g., 50%), the processor may automatically process an associated roof loss claim.

The processor 313 may execute an insurance claim data transmission module 485a to cause the processor 313 to, for example, settle an insurance claim (block 430g). For example, the processor 313 may cause a notification to be sent to an insurance adjustor, or may cause a payment to be automatically transmitted to a building owner or a repair vendor.

Turning to FIG. 4H, a method of generating insurance property loss mitigation data based on probable roof loss confidence score data 400h may be implemented by a processor (e.g., processor 313 of FIG. 3) executing, for example, at least a portion of the modules 410a-495a of FIG. 4A or the module 312 of FIG. 3. In particular, the processor 313 may receive the base-line probable roof loss confidence score data from block 435b (block 410h). The processor 313 may execute the weather data receiving module 420a to cause the processor 313 to, for example, receive weather data from a weather computing device 340 (block 415h). The weather data may be representative of storm attributes associated with storms that have recently occurred in a geographic area that includes a geographic location of the building. The attributes of the storm may include at least one of: a storm meteorological signature, a storm duration, a storm direction, a wind speed, thermal shock, whether a storm is conducive to producing damaging hail, whether a storm is conducive to producing strong winds, key meteorological aspects of a storm, length of time that the storm impacted the roof, a direction from which the storm impacts the building, a roof temperature prior to the storm, a roof temperature after the storm, or a thermal shock to roofing material.

The processor 313 may execute a hail data receiving module 425a to cause the processor 313 to, for example, receive hail data from a hail computing device based on the building data (block 420h). The hail data may be representative of attributes of hail that has recently impacted a geographic area that includes the geographic location of the building. Attributes of the hail may include at least one of: a physical characteristic of the hail, a size of the hail, a shape of the hail, a density of the hail, a hardness of the hail, a range of hail sizes produced by a storm, or a resistance to flexing of the hail.

The processor 313 may execute a probable roof loss confidence score data generation module 440a to cause the processor 313 to, for example, generate probable roof loss confidence score data based on the base-line probable roof loss confidence score data, the weather data, and the hail data (block 425h). Execution of the probable roof loss confidence score data generation module 440a may cause the processor 313 to implement a probability function to generate the base-line probable roof loss confidence score data (block 425h). A contribution of a first term of the probability function may be weighted, via a first weighting variable, relative to a second term of the probability function. The first term of the probability function may be based on the roof data. The second term of the probability function may be based on the hail data. The first weighting variable may be dynamically determined based on at least one of: the base-line probable roof loss confidence score data, the weather data, or the hail data. For example, if an associated building is located within a climate zone that does not experience hail, the hail data may be associated with a weighting variable of zero.

The processor 313 may execute an insurance property loss mitigation data generation module 490a to cause the processor 313 to, for example, generate insurance claim data based on the probable roof loss confidence score data (block 430h). The probable roof loss confidence score data may be, for example, representative of a binary value (i.e., either a roof of the building is determine to be a total loss, or not). Alternatively, the probable roof loss confidence score data may be, for example, representative of a continuous value (i.e., a probability of the roof of the building being a total loss is determine). If the probability is less than some value (e.g., 50%), a manual verification of a roof loss claim may be performed. If the probability is greater than some value (e.g., 50%), the processor may automatically process an associated roof loss claim.

The processor 313 may execute an insurance property loss mitigation data transmission module 495a to cause the processor 313 to, for example, mitigate property loss (block 430h). For example, the processor 313 may cause a notification to be sent to an insurance adjustor, or may cause a payment to be automatically transmitted to a repair vendor.

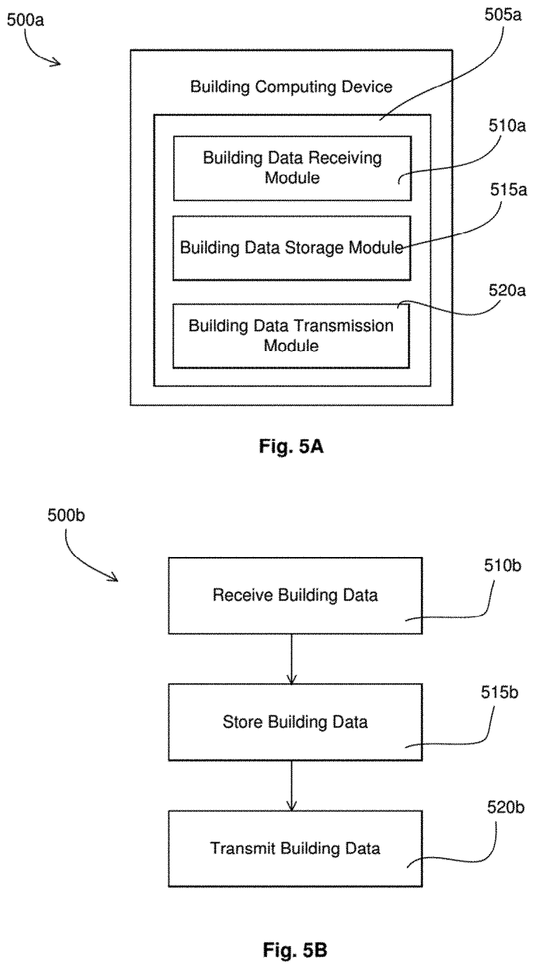

With reference to FIG. 5A, a building computing device 500a may include a building data receiving module 510a, a building data storage module 515a, and a building data transmission module 520a stored on, for example, a memory 505a as a set of computer-readable instructions. The building computing device 500a may be similar to, for example, the building computing device 320 of FIG. 3.

Turning to FIG. 5B, a method of implementing a building computing device 500b may be implemented by a processor (e.g., processor 323 of FIG. 3) executing, for example, at least a portion of the modules 510a-520a of FIG. 5A or the module 323 of FIG. 3. In particular, the processor 313 may execute the building data receiving module 510a to cause the processor 323 to, for example, receive building data from a building data source (block 510b). The building data source may be, for example, an insurance company policy master record, an insurance claim record, a real property vendor (e.g., an aerial image source, a real estate master listing source, etc.), an insurance claim file, a homeowner, crowd sourcing, or other vendor (e.g., an inspection vendor, a property inspection vendor, etc.).

At least one building data source may incorporate, for example, various internet of things (IOT) or “smart home” technology (e.g., data from video doorbells, data from security cameras, data from, etc.). The building data may include video data, photograph data, and/or audio data. The building data may include historical data for various purposes such as establishing a base-line for a particular property, or portion of a property (e.g., a roof, a building exterior, gutters, down spouts, exterior siding, exterior windows, etc.). Additionally, or alternatively, the building data may include real-time data collected at a time of an “event” (e.g., at a time of a hail storm, at a time of a wind storm, etc.).

The processor 323 may execute the building data storage module 515a to cause the processor 323 to, for example, analyze the building data, using any one of, or a collection of one or more of: a variety of automated techniques including machine learning, artificial intelligence or similar to derive insights for to enhance the accuracy of an associated probable roof loss confidence score. For example, a video doorbell or exterior security camera may detect an occurrence of hail proximate a respective building. The processor 323 may execute the building data receiving module 515a to cause the processor 323 to, for example, receive image data from a camera. The processor 323 may execute the building data storage module 515a to cause the processor 323 to, for example, estimate at least one characteristic, including but not limited to: direction of hail, size of hail, density/hardness, elevations of the structure exposed to hail, or duration of hail at the property location, based on the image data.

Likewise, audio data from similar devices, may be used for automated analysis to provide similar insights as described above. The processor 323 may execute the building data receiving module 510a to cause the processor 323 to, for example, receive audio data from at least one security microphone. The processor 323 may execute the building data storage module 515a to cause the processor 323 to, for example, detect an audio “signature” of hail that is impacting an associated building based on the audio data. The processor 323 may execute the building data transmission module 520a to cause the processor 323 to, for example, triggering event notifications to the property owner or other party that the property owner designates (e.g., an insurer, a property inspector, a property repairer, etc.) based on the audio data. The processor 323 may execute the building data storage module 515a to cause the processor 323 to, for example, estimate at least one characteristic, including: a direction of hail, size of hail, hardness, elevations of the structure exposed to hail, and/or duration of hail at the property location, based on the audio data.

The processor 323 may execute the building data storage module 515a to cause the processor 323 to, for example, store the building data (block 515b). The processor 323 may execute the building data transmission module 520a to cause the processor 323 to, for example, transmit the building data to a confidence score computing device 400a (block 520b).

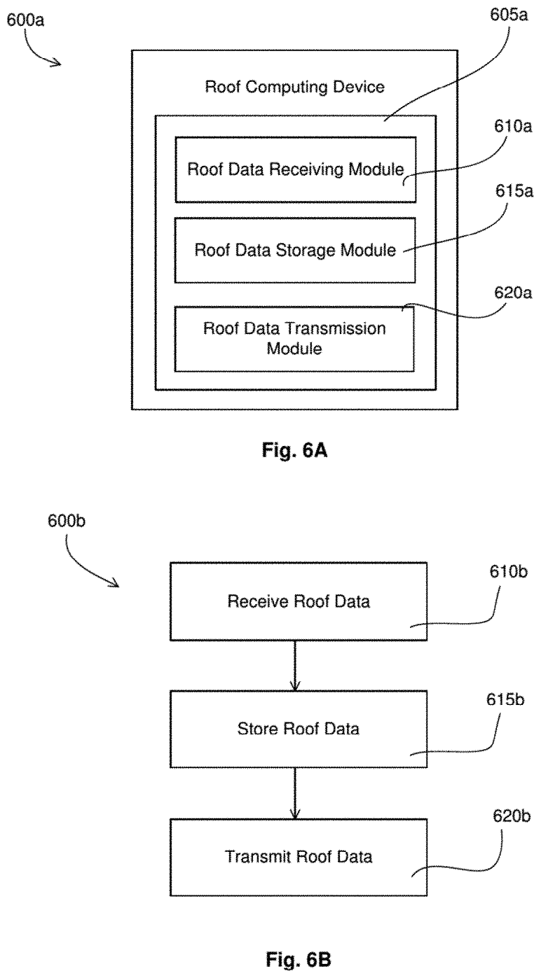

With reference to FIG. 6A, a roof computing device 600a may include a roof data receiving module 610a, a roof data storage module 615a, and a roof data transmission module 620a stored on, for example, a memory 605a as a set of computer-readable instructions. The roof computing device 600a may be similar to, for example, the roof computing device 330 of FIG. 3.

Turning to FIG. 6B, a method of implementing a roof computing device 600b may be implemented by a processor (e.g., processor 333 of FIG. 3) executing, for example, at least a portion of the modules 610a-620a of FIG. 6A or the module 332 of FIG. 3. In particular, the processor 333 may execute the roof data receiving module 610a to cause the processor 323 to, for example, receive roof data from a roof data source (block 610b). The roof data source may be, for example, an insurance company policy master record, an insurance claim record, real property vendor, a roofing material manufacture, a roofing material installer, an insurance claim file, a homeowner, crowd sourcing, or other vendor (e.g., an inspection vendor, a property inspection vendor, etc.).

At least one roof data source may incorporate, for example, various internet of things (IOT) or “smart home” technology (e.g., data from video doorbells, data from security cameras, data from, etc.). The roof data may include video data, photograph data, and/or audio data. The roof data may include historical data for various purposes such as establishing a base-line for a particular property, or portion of a property (e.g., a roof, a building exterior, gutters, down spouts, exterior siding, exterior windows, etc.). Additionally, or alternatively, the roof data may include real-time data collected at a time of an “event” (e.g., at a time of a hail storm, at a time of a wind storm, etc.).

The processor 333 may execute the roof data storage module 615a to cause the processor 333 to, for example, analyze the image and/or audio data, using any one of, or a collection of one or more of: a variety of automated techniques including machine learning, artificial intelligence or similar to derive insights for to enhance the accuracy of an associated probable roof loss confidence score. For example, a video doorbell or exterior security camera may detect an occurrence of hail proximate a respective building. The processor 333 may execute the roof data receiving module 615a to cause the processor 333 to, for example, receive image data from a camera. The processor 333 may execute the roof data storage module 615a to cause the processor 333 to, for example, estimate at least one characteristic, including but not limited to: direction of hail, size of hail, density/hardness, elevations of the structure exposed to hail, or duration of hail at the property location, based on the image data.

Likewise, audio data from similar devices, may be used for automated analysis to provide similar insights as described above. The processor 333 may execute the roof data receiving module 610a to cause the processor 333 to, for example, receive audio data from at least one security microphone. The processor 333 may execute the roof data storage module 615a to cause the processor 333 to, for example, detect an audio “signature” of hail that is impacting an associated building, based on the audio data. The processor 333 may execute the roof data transmission module 620a to cause the processor 333 to, for example, triggering event notifications to the property owner or other party that the property owner designates (e.g., an insurer, a property inspector, a property repairer, etc.) based on the audio data. The processor 333 may execute the roof data storage module 615a to cause the processor 333 to, for example, estimate at least one characteristic, including: a direction of hail, size of hail, hardness, elevations of the structure exposed to hail, and/or duration of hail at the property location, based on the audio data.

The processor 333 may execute the roof data storage module 615a to cause the processor 333 to, for example, store the roof data (block 615b). The processor 333 may execute the roof data transmission module 620a to cause the processor 333 to, for example, transmit the roof data to a confidence score computing device 400a (block 620b).

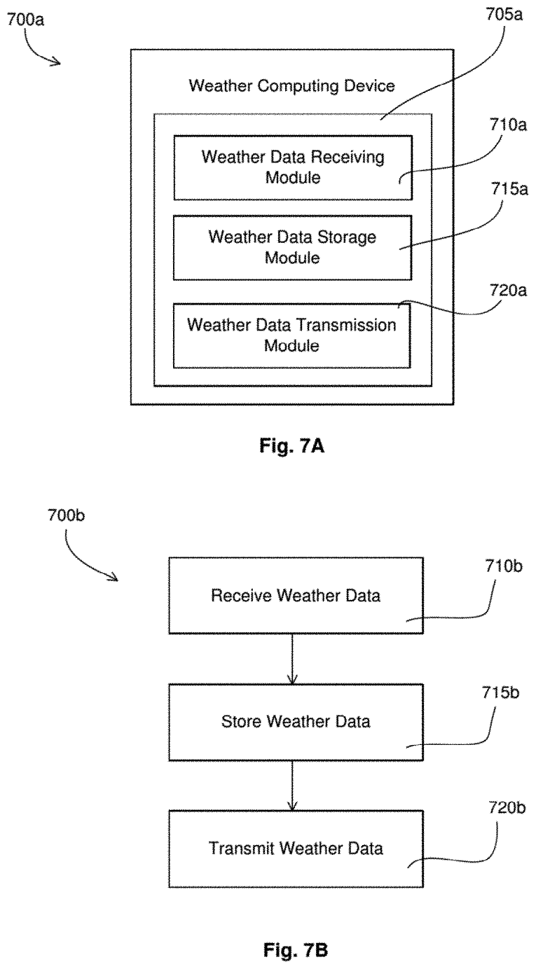

With reference to FIG. 7A, a weather computing device 700a may include a weather data receiving module 710a, a weather data storage module 715a, and a weather data transmission module 620a stored on, for example, a memory 705a as a set of computer-readable instructions. The weather computing device 700a may be similar to, for example, the weather computing device 340 of FIG. 3.

Turning to FIG. 7B, a method of implementing a weather computing device 700b may be implemented by a processor (e.g., processor 343 of FIG. 3) executing, for example, at least a portion of the modules 710a-720a of FIG. 7A or the module 342 of FIG. 3. In particular, the processor 343 may execute the weather data receiving module 710a to cause the processor 343 to, for example, receive weather data from a weather data source (block 710b). The weather data source may be, for example, an insurance company policy master record, an insurance claim file, a homeowner, crowd sourcing, or the National Oceanic and Atmospheric Administration—U.S. Department of Commerce.

The processor 343 may execute the weather data storage module 715a to cause the processor 343 to, for example, store the weather data (block 715b). The processor 343 may execute the weather data transmission module 720a to cause the processor 343 to, for example, transmit the weather data to a confidence score computing device 400a (block 720b).

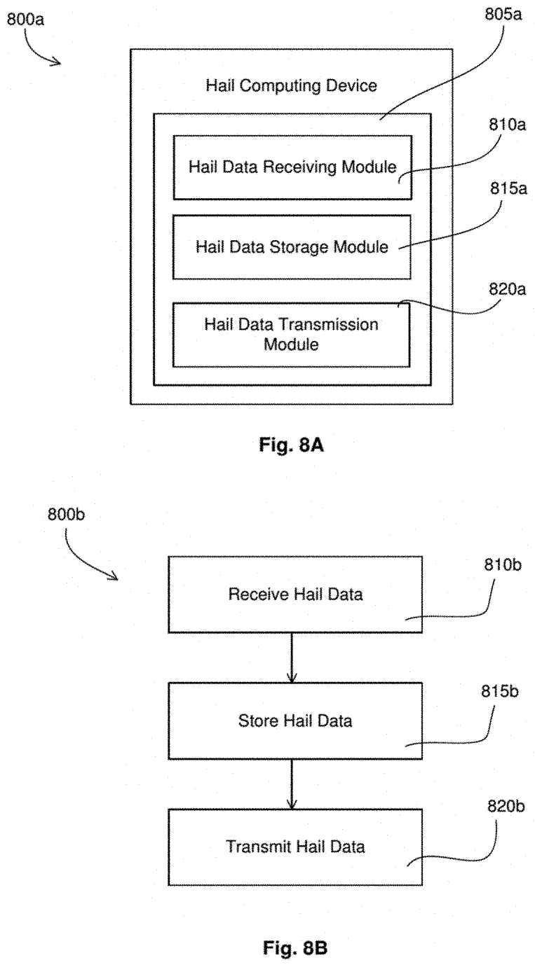

With reference to FIG. 8A, a hail computing device 800a may include a hail data receiving module 810a, a hail data storage module 815a, and a hail data transmission module 820a stored on, for example, a memory 805a as a set of computer-readable instructions. The hail computing device 800a may be similar to, for example, the hail computing device 350 of FIG. 3.

Turning to FIG. 8B, a method of implementing a hail computing device 800b may be implemented by a processor (e.g., processor 353 of FIG. 3) executing, for example, at least a portion of the modules 810a-820a of FIG. 8A or the module 352 of FIG. 3. In particular, the processor 353 may execute the hail data receiving module 810a to cause the processor 353 to, for example, receive hail data from a hail data source (block 810b). The hail data source may be, for example, an insurance company policy master record, an insurance claim file, a homeowner, crowd sourcing, or the National Oceanic and Atmospheric Administration—U.S. Department of Commerce.

At least one hail data source may incorporate, for example, various internet of things (IOT) or “smart home” technology (e.g., data from video doorbells, data from security cameras, data from, etc.). The hail data may include video data, photograph data, image data, and/or audio data. The hail data may include historical data for various purposes such as establishing a base-line for a particular property, or portion of a property (e.g., a roof, a building exterior, gutters, down spouts, exterior siding, exterior windows, etc.). Additionally, or alternatively, the hail data may include real-time data collected at a time of an “event” (e.g., at a time of a hail storm, at a time of a wind storm, etc.).

The processor 353 may execute the hail data storage module 815a to cause the processor 353 to, for example, analyze image data and/or audio data, using any one of, or a collection of one or more of: a variety of automated techniques including machine learning, artificial intelligence or similar to derive insights for to enhance the accuracy of an associated probable roof loss confidence score. For example, a video doorbell or exterior security camera may detect an occurrence of hail proximate a respective building. The processor 353 may execute the hail data receiving module 815a to cause the processor 353 to, for example, receive image data from a camera. The processor 353 may execute the hail data storage module 815a to cause the processor 353 to, for example, estimate at least one characteristic, including but not limited to: direction of hail, size of hail, density/hardness, elevations of the structure exposed to hail, or duration of hail at the property location, based on the image data.

Likewise, audio data from similar devices, may be used for automated analysis to provide similar insights as described above. The processor 353 may execute the hail data receiving module 810a to cause the processor 353 to, for example, receive audio data from at least one security microphone. The processor 353 may execute the hail data storage module 815a to cause the processor 353 to, for example, detect an audio “signature” of hail that is impacting an associated building, based on the audio data. The processor 353 may execute the hail data transmission module 820a to cause the processor 353 to, for example, triggering event notifications to the property owner or other party that the property owner designates (e.g., an insurer, a property inspector, a property repairer, etc.) based on the audio data. The processor 353 may execute the hail data storage module 815a to cause the processor 353 to, for example, estimate at least one characteristic, including: a direction of hail, size of hail, hardness, elevations of the structure exposed to hail, and/or duration of hail at the property location, based on the audio data.

The processor 353 may execute the hail data storage module 815a to cause the processor 353 to, for example, store the hail data (block 815b). The processor 353 may execute the hail data transmission module 820a to cause the processor 353 to, for example, transmit the hail data to a confidence score computing device 400a (block 820b).

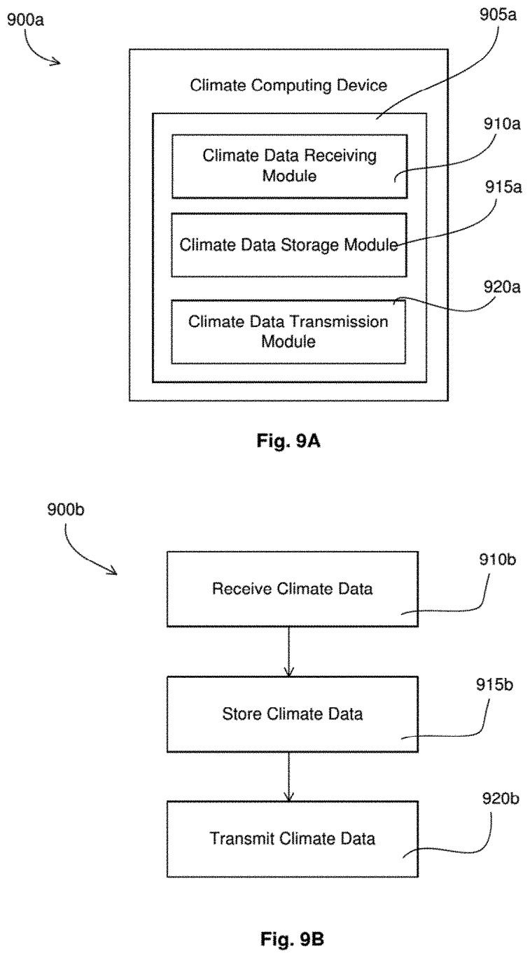

With reference to FIG. 9A, a climate zone computing device 900a may include a climate zone/region data receiving module 910a, a climate zone/region data storage module 915a, and a climate zone/region data transmission module 920a stored on, for example, a memory 905a as a set of computer-readable instructions. The climate zone computing device 900a may be similar to, for example, the climate zone computing device 360 of FIG. 3.

Turning to FIG. 9B, a method of implementing a climate zone computing device 900b may be implemented by a processor (e.g., processor 363 of FIG. 3) executing, for example, at least a portion of the modules 910a-920a of FIG. 9A or the module 362 of FIG. 3. In particular, the processor 363 may execute the climate zone/region data receiving module 910a to cause the processor 363 to, for example, receive climate zone/region data from a climate zone/region data source (block 910b). The climate zone/region data source may be, for example, an insurance company policy master record, an insurance claim file, a homeowner, crowd sourcing, or Pacific Northwest National Laboratory—U.S. Department of Energy's Building America Program.

The processor 363 may execute the climate zone/region data storage module 915a to cause the processor 363 to, for example, store the climate zone/region data (block 915b). The processor 363 may execute the climate zone/region data transmission module 920a to cause the processor 363 to, for example, transmit the climate zone/region data to a confidence score computing device 400a (block 920b).

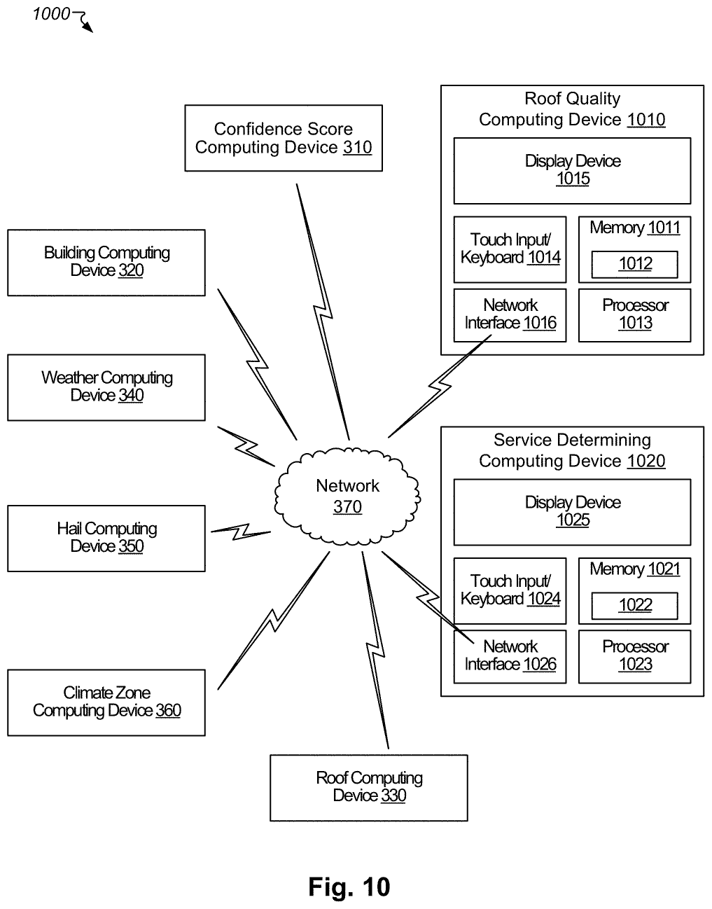

FIG. 10 is a block diagram of an example computing system 1000 that an insurance company, for example, may implement for generating enterprise data useful to the insurance company and/or third parties affiliated with the insurance company. Enterprise data may include quality metrics or ratings of the roof condition, which may include predicted current or future values. Example expected quality metrics of a roof that may be used as enterprise data include, but are not limited to, a current valuation of a roof, an estimated remaining life, an estimated percentage of a roof that may have damage, etc. Such enterprise data may be analogous to the soil productivity index ratings used to represent farmland soil quality, productivity, etc. and/or to justify land prices. Enterprise data may be data that is shared across departments of an organization, between organizations, between service providers, between third parties, etc. that provide, for example, a plurality of different services, proposals, evaluations, valuations, quotes, etc. related to roofs and/or roof damage. Such enterprise data may be used, for example, for determining service needs, aspects of service needs, evaluations, valuations, quotes, proposals, etc. for a building. For example, an insurance company may use the enterprise data for evaluating policies covering the building based upon a quality or valuation of the roof. Additionally and/or alternatively, third parties, such as building owners, inspectors, appraisers, lenders, construction contractors, etc., may use the enterprise data to estimate the quality of a roof, a current or future value of the roof, a current or future condition of the roof, etc. In some examples, the insurance company further uses the system 1000 to generate, based upon the enterprise data, quality evaluations, valuations, service need information, etc. for third parties. The third parties may use the service need information to generate, provide, etc. service proposals, quotes, evaluations, valuations, etc. for the building. In some examples, the insurance company may provide access to the system 1000 to third parties to enable the third parties to determine service needs, aspects of service needs, evaluations, valuations, quotes, proposals, etc. for a building. The third parties may use that information to generate, provide, etc. service proposals, evaluations, valuations, etc. for the building.

In one example, the system 1000 may determine as enterprise data expected values of a quality metric of a roof to a value of a building for future years, and/or service needs for the building based on base-line probable roof loss confidence score data. The base-line probable roof loss confidence score data may represent likelihoods that the roof of the building will need replacement or repair in particular future years and may be determined based on, for example, building data (e.g., a geographic location of a building (e.g., latitude, longitude, etc.), a date on which a building was built, etc.), roof data (e.g., a type of roofing material, an impact resistance rating of a roofing material, a date on which a roof was installed, a wind resistance rating of a roofing material, roof area (exposure), number of layers, manufacturer defects present, etc.), historical weather data (e.g., historical wind speeds associated with historical storms in a geographic area associated with the building, historical wind directions associated with historical storms in a geographic area associated with the building, historical lengths of time of historical storms that impacted a geographic area associated with the building, etc.), historical hail data (e.g., sizes of hail that have historically impacted a geographic area associated with the building, hardness of hail that have historically impacted a geographic area associated with the building, lengths of time hail historically impacted a geographic area associated with the building, a three-dimensional shape of the hail that has historically impacted a geographic area associated with the building, etc.).

In another example, the system 1000 may determine as enterprise data expected values of a quality metric of a roof to a value of a building for future years, and/or service needs for the building based on probable roof loss confidence score data arising from a particular storm or hail event occurring in a geographic area that includes the building. Probable roof loss confidence score data may represent a likelihood of a particular storm or a particular hail event causing a total loss of the roof and may be determined based on, for example, the building data, the roof data, the historical weather data, weather event data, the historical hail data, and hail event data.

The system 1000 may provide the enterprise data, which may be expected values of the quality metric of the roof to the value of the building for future years and/or service needs for the building, to at least one of an owner of the building, a maintenance entity associated with the building, an insurer for the building, a loan entity associated with the building, a contractor that might perform a proposed service, a supplier that might provide materials for a proposed service, etc.

The system 1000 includes the confidence score computing device 310, the building computing device 320, the roof computing device 330, the weather computing device 340, the hail computing device 350, the climate zone computing device 360, an example roof quality computing device 1010, and an example service determining computing device 1020 communicatively connected to one another via the communications network 370. For clarity, only one confidence score computing device 310, one building computing device 320, one roof computing device 330, one weather computing device 340, one hail computing device 350, one climate zone computing device 360, one roof quality computing device 1010 and one service determining computing device 1020 are depicted in FIG. 10. While only one confidence score computing device 310, one building computing device 320, one roof computing device 330, one weather computing device 340, one hail computing device 350, one climate zone computing device 360, one roof quality computing device 1010 and one service determining computing device 1020 are depicted in FIG. 10, it should be understood that any number of confidence score computing devices 310, building computing devices 320, roof computing devices 330, weather computing devices 340, hail computing devices 350, climate zone computing devices 360, roof quality computing devices 1010 and service determining computing devices 1020 may be supported within the computing system 1000.

The confidence score computing device 310, the building computing device 320, the roof computing device 330, the weather computing device 340, the hail computing device 350 and the climate zone computing device 360 are described above in connection with at least FIGS. 3, 4a, 4b, 4f, 5a, 5b, 6a, 6b, 7a, 7b, 8a, 8b, 9a and 9b. For conciseness, descriptions of the confidence score computing device 310, the building computing device 320, the roof computing device 330, the weather computing device 340, the hail computing device 350 and the climate zone computing device 360 will not be repeated here. Instead, the interested reader is referred to the descriptions of the confidence score computing device 310, the building computing device 320, the roof computing device 330, the weather computing device 340, the hail computing device 350 and the climate zone computing device 360 provided above in connection with at least FIGS. 3, 4a, 4b, 4f, 5a, 5b, 6a, 6b, 7a, 7b, 8a, 8b, 9a and 9b.

The roof quality computing device 1010 may include a memory 1011 and a processor 1013 for storing and executing, respectively, a module 1012. The module 1012 may be, for example, stored on the memory 1011 as a set of computer-readable instructions that, when executed by the processor 1013, may cause the processor 1013 or, more generally, the roof quality computing device 1010 to generate expected values of a quality metric of a roof to the value of a building for future years as enterprise data based upon roof data, base-line probable roof loss confidence scores and/or a probable roof loss confidence score generated by the confidence score computing device 310. The roof quality computing device 1010 may include a touch input/keyboard 1014, a display device 1015, and a network interface 1016 configured to facilitate communications between the roof quality computing device 1010, the confidence score computing device 310, the building computing device 320, the roof computing device 330, the weather computing device 340, the hail computing device 350, the climate zone computing device 360 and the service determining computing device 1020 via any hardwired or wireless communication network link, including, for example, a wireless LAN, MAN or WAN, WiFi, a wireless cellular telephone network, an Internet connection, etc. or any combination thereof. Moreover, the roof quality computing device 1010 may be communicatively connected to the confidence score computing device 310, the building computing device 320, the roof computing device 330, the weather computing device 340, the hail computing device 350, the climate zone computing device 360 and the service determining computing device 1020 via any suitable communication system, such as via any publicly available or privately owned communication network 370, including those that use wireless communication structures, such as wireless communication networks, including for example, wireless LANs and WANs, satellite and cellular telephone communication systems, etc.

Example expected values of a quality metric of a roof that may be generated as enterprise data by the roof quality computing device 1010 include, but are not limited to, (i) a current value of a roof, (ii) an estimated remaining life, (iii) an estimated percentage of a roof that may have damage, (iv) increases in the expected values of a quality metric if a proposed repair or replacement is performed, (v) an increase in a value of a building if a proposed repair or replacement is performed, etc.

The service determining computing device 1020 may include a memory 1021 and a processor 1023 for storing and executing, respectively, a module 1022. The module 1022 may be, for example, stored on the memory 1021 as a set of computer-readable instructions that, when executed by the processor 1023, may cause the processor 1023 or, more generally, the service determining computing device 1020 to determine an aspect of a service for the building, identify a proposed service, generate a service proposal, evaluate a roof, valuate a roof, etc. based on enterprise data (e.g., expected values of the quality metric(s) of the roof determined by the roof quality computing device 1010), base-line probable roof loss confidence scores and/or a probable roof loss confidence score generated by the confidence score computing device 310. The service determining computing device 1020 may include a touch input/keyboard 1024, a display device 1025, and a network interface 1026 configured to facilitate communications between the service determining computing device 1020, the confidence score computing device 310, the building computing device 320, the roof computing device 330, the weather computing device 340, the hail computing device 350, the climate zone computing device 360 and the roof quality computing device 1010 via any hardwired or wireless communication network link, including, for example, a wireless LAN, MAN or WAN, WiFi, a wireless cellular telephone network, an Internet connection, etc. or any combination thereof. Moreover, the service determining computing device 1020 may be communicatively connected to the confidence score computing device 310, the building computing device 320, the roof computing device 330, the weather computing device 340, the hail computing device 350, the climate zone computing device 360 and the roof quality computing device 1010 via any suitable communication system, such as via any publicly available or privately owned communication network 370, including those that use wireless communication structures, such as wireless communication networks, including for example, wireless LANs and WANs, satellite and cellular telephone communication systems, etc.

Example aspects of services, services, evaluations, valuations, etc. that may be determined or performed by the service determining computing device 1020 based on enterprise data include, but are not limited to (i) one or more parameters of a loan for a building based upon expected values of a quality metric of a roof, (ii) an asking price for an offer for sale for a building based upon expected values of a quality metric of a roof, (iii) an insured value and/or a replacement cost for a building for an insurance policy based upon building data, roof data, and expected values of a quality metric of a roof, (iv) probable costs associated with maintaining and/or replacing a roof in future years based upon building data, roof data and t base-line probable roof loss confidence scores, (v) an inspection report for a building that includes base-line probable roof loss confidence scores and probable costs, (vi) an appraisal value of a building based upon expected values of a quality metric of a roof, (vii) an estimated cost to repair or replace a roof based upon building data and roof data, (viii) an estimate of materials need to perform a proposed service, (ix) determining an aspect of a proposed roof replacement or repair, (x) automatically sending an inspector when a probable roof loss confidence score satisfies a threshold, (xi) automatically processing an insurance payment when a probable roof loss confidence score satisfies a threshold, etc.

In an example, the confidence score computing device 310 determines a plurality of probable roof loss confidence scores for respective ones of a plurality of buildings in a geographic area, the roof quality computing device 1010 determines enterprise data (e.g., expected values of a quality metric for roofs of the plurality of buildings) and the service determining computing device 1020 uses the enterprise data to determine service needs for the geographic area. For example, the service determining computing device 1020 may determine based on the enterprise data (i) a number of insurance adjusters needed over a time interval following a particular storm or particular hail event, (ii) an estimated amount of materials needed in the geographic area to replace or repair roofs damaged by the particular storm or the particular hail event, (iii) a list of buildings needing roof repair or roof replacement based upon each of the buildings having a corresponding roof loss confidence score exceeding a threshold, (iv) a prioritization of the list of buildings, etc.

In some examples, the confidence score computing device 310 determines updated base-line probable roof loss confidence scores assuming that a proposed service is performed, and the roof quality computing device 1010 determines updated enterprise data (e.g., updated quality metrics) based on the updated base-line probable roof loss confidence scores. Such updated quality metrics may be, for example, included in a service proposal generated by the service determining computing device 1020 as motivation and/or justification to perform a proposed service.

By distributing the memory, data and processing among the confidence score computing devices 310, the building computing devices 320, the roof computing devices 330, the weather computing devices 340, the hail computing devices 350, the climate zone computing devices 360, the roof quality computing device 1010 and the service determining computing device 1020, as shown in FIGS. 3 and 10, the overall capabilities of the system 1000 may be optimized. Furthermore, the individual data sources (e.g., the building data, the roof data, the weather data, the hail data, and the climate zone/region data) may be updated and maintained by different entities. Therefore, updating and maintaining the associated data is more efficient and secure.

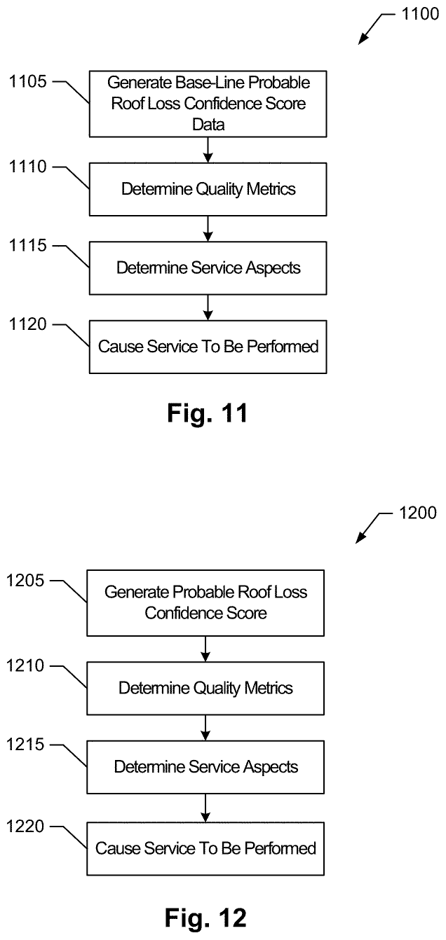

FIG. 11 is a flowchart representing an example method 1100 for determining enterprise data and service needs, services, aspects of services, quotes, evaluations, valuations, proposals, etc. for a building based on base-line probable roof loss confidence score data. The method 1100 may be implemented by a processor (e.g., processor 1023 of FIG. 10) by executing, for example, the modules 410a-435a of FIG. 4A to implement the example flowchart 400b of FIG. 4B to generate base-line probable roof loss confidence score data (block 1105). For example, the processor may (A) obtain (i) building data (e.g., a geographic location of a building (e.g., latitude, longitude, etc.), a date on which a building was built, etc.), (ii) roof data (e.g., a type of roofing material, an impact resistance rating of a roofing material, a date on which a roof was installed, a wind resistance rating of a roofing material, roof area (exposure), number of layers, manufacturer defects present, etc.), (iii) historical weather data (e.g., historical wind speeds associated with historical storms in a geographic area associated with the building, historical wind directions associated with historical storms in a geographic area associated with the building, historical lengths of time of historical storms that impacted a geographic area associated with the building, etc.), (iv) historical hail data (e.g., sizes of hail that have historically impacted a geographic area associated with the building, hardness of hail that have historically impacted a geographic area associated with the building, lengths of time hail historically impacted a geographic area associated with the building, a three-dimensional shape of the hail that has historically impacted a geographic area associated with the building, etc.), and (v) climate zone/region data; and (B) determine base-line probable roof loss confidence score data (e.g., likelihoods that the roof of the building will need replacement or repair in particular future years) based on the obtained building data, roof data, historical weather data, historical hail data, and climate zone/region data.

The processor 1023 may execute the service determining computing device module 1022 to cause the processor 1023 to determine, as enterprise data, expected values of a quality metric of the roof to the value of the building for future years based upon the roof data and the generated base-line probable roof loss confidence scores (block 1110). Example quality metrics of the roof that may be used as enterprise data include, but are not limited to, (i) a current value of a roof, (ii) an estimated remaining life, (iii) an estimated percentage of a roof that may have damage, (iv) increases in the expected values of a quality metric if a proposed repair or replacement is performed, (v) an increase in a value of a building if a proposed repair or replacement is performed, etc. In some embodiments, a plurality of such quality metrics or a plurality of values of a particular quality metric may be generated. For example, an expected value and one or more values relating to a probability distribution for a quality metric (e.g., quintile or quartile values) may be generated. In further embodiments, one or more values of combined quality metrics may be generated from a weighted combination of other quality metrics and/or roof loss confidence scores.

The processor 1023 may execute the roof quality computing device module 1012 to cause the processor 1023 to determine services, aspects of services, quotes, evaluations, valuations, proposals, etc. based on the enterprise data (e.g., the expected values of the quality metric of the roof to the value of the building for the future years) (block 1115).

Example aspects of services, evaluations, valuations, etc. that may be determined or performed based on the enterprise data include, but are not limited to (i) one or more parameters of a loan for a building based upon expected values of a quality metric of a roof, (ii) an asking price for an offer for sale for a building based upon expected values of a quality metric of a roof, (iii) an insured value and/or a replacement cost for a building for an insurance policy based upon building data, roof data, and expected values of a quality metric of a roof, (iv) probable costs associated with maintaining and/or replacing a roof in future years based upon building data, roof data and base-line probable roof loss confidence scores, (v) an inspection report for a building that includes base-line probable roof loss confidence scores and probable costs, (vi) an appraisal value of a building based upon expected values of a quality metric of a roof, (vii) an estimated cost to repair or replace a roof based upon building data and roof data, (viii) an estimate of materials need to perform a proposed service, (ix) determining an aspect of a proposed roof replacement or repair, (x) automatically sending an inspector when a probable roof loss confidence score satisfies a threshold, (xi) automatically processing an insurance payment when a probable roof loss confidence score satisfies a threshold, etc.

The processor 1023 may cause the service to be performed by, for example, providing a proposal, providing an inspection report, providing an appraisal report, providing a quote, etc. to, for example, at least one of an owner of the building, a maintenance entity associated with the building, an insurer for the building, a loan entity associated with the building, a contractor that might perform a proposed service, a supplier that might provide materials for a proposed service, etc. (block 1120). In some embodiments, the processor 1023 may automatically generate a report, send a work order, or schedule maintenance/repair for the building based upon the one or more values of quality metrics exceeding a maximum threshold or falling below a minimum threshold. In further embodiments, the processor 1023 may cause the service to be performed in response to receiving user input from a system operator after presenting one or more determined services or aspects of services, together with one or more values of quality metrics in some such embodiments. In yet further embodiments, causing a service to be performed may include sending enterprise data required for the performance of such service to an entity (e.g., a user, property owner, or third party service provider) performing such service.

FIG. 12 is a flowchart representing an example method 1200 for determining enterprise data and service needs, services, aspects of services, quotes, evaluations, valuations, proposals, etc. for a building based on a probable roof loss confidence score. The method 1200 may be implemented by a processor (e.g., processor 1023 of FIG. 10) by executing, for example, the modules 410a-440a of FIG. 4A to implement the example flowchart 400f of FIG. 4F to generate a probable roof loss confidence score (block 1205). For example, the processor may (A) obtain (i) building data (e.g., a geographic location of a building (e.g., latitude, longitude, etc.), a date on which a building was built, etc.), (ii) roof data (e.g., a type of roofing material, an impact resistance rating of a roofing material, a date on which a roof was installed, a wind resistance rating of a roofing material, roof area (exposure), number of layers, manufacturer defects present, etc.), (iii) historical weather data (e.g., historical wind speeds associated with historical storms in a geographic area associated with the building, historical wind directions associated with historical storms in a geographic area associated with the building, historical lengths of time of historical storms that impacted a geographic area associated with the building, etc.), (iv) weather event data (e.g., wind speeds associated with a storm in a geographic area associated with the building, wind directions associated with a storm in a geographic area associated with the building, a length of time of a storm impacted a geographic area associated with the building, etc.), (v) historical hail data (e.g., sizes of hail that have historically impacted a geographic area associated with the building, hardness of hail that have historically impacted a geographic area associated with the building, lengths of time hail historically impacted a geographic area associated with the building, a three-dimensional shape of the hail that has historically impacted a geographic area associated with the building, etc.), (vi) hail event data (e.g., sizes of hail that impacted a geographic area associated with the building during a hail event, hardness of hail that impacted a geographic area associated with the building during a hail event, length of time hail impacted a geographic area associated with the building during a hail event, a three-dimensional shape of the hail that impacted a geographic area associated with the building during a hail event, etc.), and (vii) climate zone/region data; and (B) determine a probable roof loss confidence score (e.g., a likelihood that the roof of the building needs replacement or repair after the weather or hail event) based on the obtained building data, roof data, historical weather data, weather event data, historical hail data, hail event data, and climate zone/region data.

The processor 1023 may execute the service determining computing device module 1022 to cause the processor 1023 to determine, as enterprise data, expected values of a quality metric of the roof to the value of the building for future years based upon the roof data and the generated probable roof loss confidence score (block 1210). Example quality metrics of the roof that may be used as enterprise data include, but are not limited to, (i) a current value of a roof, (ii) an estimated remaining life, (iii) an estimated percentage of a roof that may have damage, (iv) increases in the expected values of a quality metric if a proposed repair or replacement is performed, (v) an increase in a value of a building if a proposed repair or replacement is performed, etc. In some embodiments, a plurality of such quality metrics or a plurality of values of a particular quality metric may be generated. For example, an expected value and one or more values relating to a probability distribution for a quality metric (e.g., quintile or quartile values) may be generated. In further embodiments, one or more values of combined quality metrics may be generated from a weighted combination of other quality metrics and/or roof loss confidence scores.

The processor 1023 may execute the roof quality computing device module 1012 to cause the processor 1023 to determine services, aspects of services, quotes, evaluations, valuations, proposals, etc. based on the enterprise data (e.g., the expected values of the quality metric of the roof to the value of the building for the future years) (block 1215).

Example aspects of services, services, evaluations, valuations, etc. that may be determined or performed based on the enterprise data include, but are not limited to (i) one or more parameters of a loan for a building based upon expected values of a quality metric of a roof, (ii) an asking price for an offer for sale for a building based upon expected values of a quality metric of a roof, (iii) an insured value and/or a replacement cost for a building for an insurance policy based upon building data, roof data, and expected values of a quality metric of a roof, (iv) probable costs associated with maintaining and/or replacing a roof in future years based upon building data, roof data and base-line probable roof loss confidence scores, (v) an inspection report for a building that includes base-line probable roof loss confidence scores and probable costs, (vi) an appraisal value of a building based upon expected values of a quality metric of a roof, (vii) an estimated cost to repair or replace a roof based upon building data and roof data, (viii) an estimate of materials need to perform a proposed service, (ix) determining an aspect of a proposed roof replacement or repair, (x) automatically sending an inspector when a probable roof loss confidence score satisfies a threshold, (xi) automatically processing an insurance payment when a probable roof loss confidence score satisfies a threshold, etc.

The processor 1023 may cause the service to be performed by providing a proposal, providing an inspection report, providing an appraisal report, providing a quote, etc. to, for example, at least one of an owner of the building, a maintenance entity associated with the building, an insurer for the building, a loan entity associated with the building, a contractor that might perform a proposed service, a supplier that might provide materials for a proposed service, etc. (block 1220). In some embodiments, the processor 1023 may automatically generate a report, send a work order, or schedule maintenance/repair for the building based upon the one or more values of quality metrics exceeding a maximum threshold or falling below a minimum threshold. For example, when an expected value of a quality metric associated with roof damage exceeds an automatic action threshold, the processor 1023 may automatically cause a claim to be generated using an estimate of the damage or may automatically cause an inspection for repair work to be scheduled. In further embodiments, the processor 1023 may cause the service to be performed in response to receiving user input from a system operator after presenting one or more determined services or aspects of services, together with one or more values of quality metrics in some such embodiments. In yet further embodiments, causing a service to be performed may include sending enterprise data required for the performance of such service to an entity (e.g., a user, property owner, or third party service provider) performing such service.

### ADDITIONAL CONSIDERATIONS

This detailed description is to be construed as exemplary only and does not describe every possible embodiment, as describing every possible embodiment would be impractical, if not impossible. One may implement numerous alternate embodiments, using either current technology or technology developed after the filing date of this application.

Further to this point, although some embodiments described herein utilize sensitive information (e.g., personal identification information, credit information, income information, etc.), the embodiments described herein are not limited to such examples. Instead, the embodiments described herein may be implemented in any suitable environment in which it is desirable to identify and control specific type of information. For example, the aforementioned embodiments may be implemented by a financial institution to identify and contain bank account statements, brokerage account statements, tax documents, etc. To provide another example, the aforementioned embodiments may be implemented by a lender to not only identify, re-route, and quarantine credit report information, but to apply similar techniques to prevent the dissemination of loan application documents that are preferably delivered to a client for signature in accordance with a more secure means (e.g., via a secure login to a web server) than via email.

Furthermore, although the present disclosure sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims. Although the following text sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software), may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of some of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless it is obvious that it is meant otherwise.

The patent claims at the end of this patent application are not intended to be construed under 35 U.S.C. § 112(f) unless traditional means-plus-function language is expressly recited, such as “means for” or “step for” language being explicitly recited in the claim(s).

This detailed description is to be construed as exemplary only and does not describe every possible embodiment, as describing every possible embodiment would be impractical, if not impossible. One may be implement numerous alternate embodiments, using either current technology or technology developed after the filing date of this application.

What is claimed is:

1. A computer-implemented method for determining an aspect of a service for a building, the method comprising:
receiving, at one or more processors, building data representative of attributes of a building, wherein the building data includes a geographical location of the building;
obtaining, by the one or more processors and based upon the building data, (i) roof data representative of a structure forming a roof of the building, (ii) historical weather data representative of storm attributes associated with historical storms that have occurred in a geographic area that includes the geographic location of the building, (iii) historical hail data representative of attributes of historical hail that has impacted a geographic area that includes the geographic location of the building, and (iv) climate region data associated with the geographic location of the building;
generating, by the one or more processors, base-line probable roof loss confidence scores based upon the building data, the roof data, the historical weather data, the historical hail data, and the climate region data, wherein the base-line probable roof loss confidence scores represent likelihoods that the roof of the building will need replacement or repair in respective future years;
determining, by the one or more processors, expected values of a quality metric of the roof to the value of the building for the future years based upon the roof data and the base-line probable roof loss confidence scores; and
determining, by the one or more processors, an aspect of a service for the building based upon the expected values of the quality metric of the roof.

2. The method of claim 1, wherein determining the aspect of the service includes generating one or more parameters of a loan for the building based upon the expected values of the quality metric of the roof.

3. The method of claim 1, wherein determining the aspect of the service includes generating an asking price for an offer for sale for the building based upon the expected values of the quality metric of the roof.

4. The method of claim 1, wherein determining the aspect of the service includes generating an insured value and/or a replacement cost for the building for an insurance policy based upon the building data, the roof data, and the expected values of the quality metric of the roof.

5. The method of claim 1, wherein determining the aspect of the service includes determining probable costs associated with maintaining and/or replacing the roof in the future years based upon the building data, the roof data and the base-line probable roof loss confidence scores.

6. The method of claim 5, further comprising generating an inspection report for the building that includes the base-line probable roof loss confidence scores and the probable costs.

7. The method of claim 1, wherein determining the aspect of the service includes generating an appraisal value of the building based upon the expected values of the quality metric of the roof.

8. The method of claim 1, wherein determining the expected values of the quality metric of the roof includes determining a current value of the roof, and wherein determining the aspect of the service includes determining an estimated cost to replace the roof based upon the building data and the roof data.

9. The method of claim 1, wherein generating the base-line probable roof loss confidence scores includes implementing a probability function, wherein a contribution of a first term of the probability function is weighted, via a first weighting variable, relative to a second term of the probability function, and wherein the first term of the probability function is based upon the roof data, and wherein the second term of the probability function is based upon the hail data.

10. A non-transitory, computer-readable medium storing instructions that, when executed by one or more processors, cause a system to:
receive building data representative of attributes of a building, wherein the building data includes a geographical location of the building;
obtain, based upon the building data, (i) roof data representative of a structure forming a roof of the building, (ii) historical weather data representative of storm attributes associated with historical storms that have occurred in a geographic area that includes the geographic location of the building, (iii) historical hail data representative of attributes of historical hail that has impacted a geographic area that includes the geographic location of the building, and (iv) climate region data associated with the geographic location of the building;
generate base-line probable roof loss confidence scores based upon the building data, the roof data, the historical weather data, the historical hail data and the climate region data, wherein the base-line probable roof loss confidence scores represent likelihoods that the roof of the building will need replacement or repair in respective future years;
determine expected values of a quality metric of the roof to the value of the building for the future years based upon the roof data and the base-line probable roof loss confidence scores; and
determine an aspect of a service for the building based upon the expected values of the quality metric of the roof.

11. The computer-readable medium of claim 10, wherein the instructions, when executed by the one or more processors, cause the system to determine the aspect of the service by generating an insured value and/or a replacement cost for the building for an insurance policy based upon the building data, the roof data, and the expected values of the quality metric of the roof.

12. The computer-readable medium of claim 10, wherein the instructions, when executed by the one or more processors, cause the system to determine the aspect of the service by determining probable costs associated with maintaining and/or replacing the roof in the future years based upon the building data, the roof data, and the expected values of the quality metric of the roof.

13. The computer-readable medium of claim 12, wherein the instructions, when executed by the one or more processors, cause the system to generate an inspection report for the building that includes the base-line probable roof loss confidence scores and the probable costs.

14. The computer-readable medium of claim 10, wherein the instructions, when executed by the one or more processors, cause the system to determine the aspect of the service by generating an appraisal value of the building based upon the expected values of the quality metric of the roof.

15. A computer-implemented method for proposing a service for a roof of a building, the method comprising:
receiving, at one or more processors, building data representative of attributes of a building, wherein the building data includes a geographical location of the building;
obtaining, by the one or more processors and based upon the building data, (i) roof data representative of a structure forming a roof of the building, (ii) historical weather data representative of storm attributes associated with historical storms that have occurred in a geographic area that includes the geographic location of the building, (iii) historical hail data representative of attributes of historical hail that has impacted a geographic area that includes the geographic location of the building, and (iv) climate region data associated with the geographic location of the building;
generating, by the one or more processors, base-line probable roof loss confidence scores based upon the building data, the roof data, the historical weather data, the historical hail data and the climate region data, wherein the base-line probable roof loss confidence scores represent likelihoods that the roof of the building will need replacement or repair in respective future years;
determining, by the one or more processors, probable costs associated with maintaining or replacing the roof in the future years based upon the base-line probable roof loss confidence scores; and
proposing, by the one or more processors, a service to be performed on the roof based upon the probable costs, the building data, the roof data, the historical weather data, the historical hail data and the climate region data.

16. The method of claim 15, wherein the service to be performed includes replacing the roof with a proposed roof, and the method further comprises determining an aspect of the proposed roof based upon at least one of the historical weather data, the historical hail data or the climate region data.

17. The method of claim 16, further comprising:
generating, by the one or more processors, updated base-line probable roof loss confidence scores based upon the building data, roof data for the proposed roof, the historical weather data, the historical hail data and the climate region data, wherein the updated base-line probable roof loss confidence scores represent likelihoods that the proposed roof will need replacement or repair in respective future years; and
determining, by the one or more processors, increases in expected values of a quality metric of the roof to the value of the building for the future years based upon the updated base-line probable roof loss confidence scores; and
preparing, by the one or more processors, a proposal for the service that includes the increases in expected values.

18. The method of claim 15, further comprising providing, by the one or more processors, at least one of the base-line probable roof loss confidence scores or the probable costs to at least one of an owner of the building, a maintenance entity associated with the building, an insurer for the building, a loan entity associated with the building, a contractor that might perform a proposed service, or a supplier that might provide materials for a proposed service.

19. The method of claim 15, further comprising estimating, by the one or more processors, materials needed to complete the proposed service based upon the building data, the roof data, the historical weather data, the historical hail data and the climate region data.

20. The method of claim 15, wherein generating the base-line probable roof loss confidence scores includes implementing a probability function, wherein a contribution of a first term of the probability function is weighted, via a first weighting variable, relative to a second term of the probability function, and wherein the first term of the probability function is based upon the roof data, and wherein the second term of the probability function is based upon the hail data.
